(19) United States
(12) Patent Application Publication
(10) Pub. No.: US 2022/0391818 A1
(43) Pub. Date: Dec. 8, 2022

(54) NEXT BEST ACTION RECOMMENDATION SYSTEM FOR STOCHASTIC TIMELINE

(71) Applicant: Introhive Services Inc., Fredericton (CA)

(72) Inventor: Amy PALMER, Fredericton (CA)

(21) Appl. No.: 17/831,064

(22) Filed: Jun. 2, 2022

Related U.S. Application Data
(60) Provisional application No. 63/196,201, filed on Jun. 2, 2021.

(51) Int. Cl. G06Q 10/06

(52) U.S. Cl. CPC G06Q 10/063118; G06Q 10/06393

(57) ABSTRACT

System and method comprising: collecting, using automated data collection, data about a plurality of opportunities that include historic opportunities and at least one current opportunity; performing matrix factorization to compute, based on the collected data, an approximated interaction matrix that includes predictions for a set of dynamic variables for the current opportunity; and outputting a recommendation of one or more actions for achieving the milestone for the current opportunity based on the predictions for the set of the dynamic variables for the current opportunity.

### RELATED APPLICATIONS

This application claims priority to and benefit of U.S. Provisional Patent Application No. 63/196,201 filed Jun. 2, 2021, the contents of which are incorporated herein by reference.

### FIELD

The present disclosure relates to automated methods and systems for enabling a computer system to transform and efficiently process digital information about past opportunities and ongoing opportunities to recommend future actions.

### BACKGROUND

Enterprises such as companies, accounting firms, law firms, universities, partnerships, agencies and governments commonly use customer relationship management (CRM) systems and related technology to manage copious amounts of digital data about relationships and interactions with other parties such as customers and potential customers. In particular, CRM systems typically employ electronic computing and communications devices that enable real world data to be collected and transformed for use in tasks related to one or more of contact management, sales management and calendar management. An important function provided by CRM systems is digital tracking, transformation and storage of data about third parties such as customers and potential customers.

There are solutions that exist today that will help identify sales cycles and sales opportunities. These solutions often contain static advice based on defined rules such as “Make a follow-up contact with your client within 10 days of providing a demonstration”. This static feedback does not account for individual differences in selling style, or client type. Rather, such feedback is based on ‘Accepted Best Practices’ that have been aggregated over a plurality of companies selling into a plurality of different industries.

A problem with such solutions is that the ‘Accepted Best Practices’ are based on manual gathering and analysis of cross-industry data based on many subjective factors. Interpreting generalized accepted best practices in the context of an ongoing sales cycle by a specific sales person in a specific industry can result in generalized advice that is of limited value. Known solutions essentially codify human activities into a computerized system, rather than taking full advantage of the data transformation and processing solutions that are enabled in a computerized environment.

Accordingly, there is a need for methods and systems that can configure a computerized solution that enables data from past transactions to be gathered and transformed into a structure that can be efficiently and accurately processed in a computerized environment to identify successful patterns, and predict, based on data from an ongoing transaction and the identified patterns, what future actions should be taken to optimize a successful outcome.

The foregoing examples of the related art and limitations thereto are intended to be illustrative and not exclusive.

### SUMMARY

According to a first example aspect, a computer implemented method is provided that includes collecting, using automated data collection, data about a plurality of opportunities that include historic opportunities and at least one current opportunity; generating, for each of the historic opportunities, a respective static feature vector that comprises a plurality of static variables that describe respective properties of the historic opportunities; generating, for the current opportunity, a static feature vector that comprises a plurality of static variables that describe respective properties of the current opportunity; determining, for each of the historic opportunities, a respective set of dynamic variables that correspond to actions taken during the course of the historic opportunity; generating a base interaction matrix that includes the set of dynamic variables determined for each of the historic opportunities corresponding to the achievement of one or many milestones; generating a static matrix that includes the respective static feature vector for each of the historic opportunities; performing matrix factorization to compute, based on the base interaction matrix and the static matrix, an approximated interaction matrix that includes predictions for a set of the dynamic variables for the current opportunity as they correspond to upcoming milestones; and outputting a recommendation of one or more actions for achieving a next milestone for the current opportunity based on the predictions for the set of the dynamic variables for the current opportunity.

In some examples, the method includes selecting the next milestone from a plurality of possible milestones.

According to a second example aspect, a system that includes one or more processors and one or more non-volatile storages coupled to the one or more processers and including software instructions that when executed by the processor configure the system to perform the above method.

### BRIEF DESCRIPTION OF THE DRAWINGS

Reference will now be made, by way of example, to the accompanying drawings which show example embodiments of the present application, and in which:

FIG. 1 is a block diagram illustrating an environment that includes an enterprise network, CRM support system and CRM system in accordance with an example embodiment of the present disclosure.

FIG. 2 is a block diagram of a data compilation module that can be included in the environment of FIG. 1

FIG. 3 is a block diagram illustrating an example of a timeline for an opportunity that can be tracked by one or more of the systems of FIG. 1, according to an example embodiment.

FIG. 4 is a block diagram of a next best action module that can be included in the environment of FIG. 1.

FIG. 5 shows an example of a deal matrix.

FIGS. 6 and 7 show examples of an interaction matrix.

FIG. 8 is a block diagram of a matrix factorization operation of the next best action module of FIG. 4.

FIG. 9 shows an example of a latent variable matrix.

FIG. 10 shows an example of an approximated interaction matrix.

FIG. 11 is a block diagram of a recommendation determination operation of the next best action module of FIG. 4.

FIG. 12 shows an alternative example of an interaction matrix.

FIG. 13 shows an alternative example of a latent variable matrix.

FIG. 14 shows an alternative example of an approximated interaction matrix.

FIG. 15 is a block diagram illustrating an example computer system for implementing one or more of the systems, modules and components shown in the environment of FIG. 1.

Similar reference numerals may have been used in different figures to denote similar components.

### DESCRIPTION OF EXAMPLE EMBODIMENTS

The following embodiments and aspects thereof are described and illustrated in conjunction with systems, tools and methods which are meant to be exemplary and illustrative, not limiting in scope.

Embodiments will now be described more fully hereinafter with reference to the accompanying drawings, in which some, but not all, embodiments of the invention are shown. The features and aspects presented in this disclosure may be embodied in many different forms and should not be construed as limited to the embodiments set forth herein. Where possible, any terms expressed in the singular form herein are meant to also include the plural form and vice versa, unless explicitly stated otherwise. In the present disclosure, use of the term “a”, “an”, or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements. As used herein, statements that a second item (e.g., a value, score, computation, prediction, or determination) is “based on” a first item can mean that characteristics of the second item are affected or determined at least in part by characteristics of the first item. The first item can be considered an input to an operation or calculation, or a series of operations or calculations that produces the second item as an output that is not independent from the first item.

System Overview

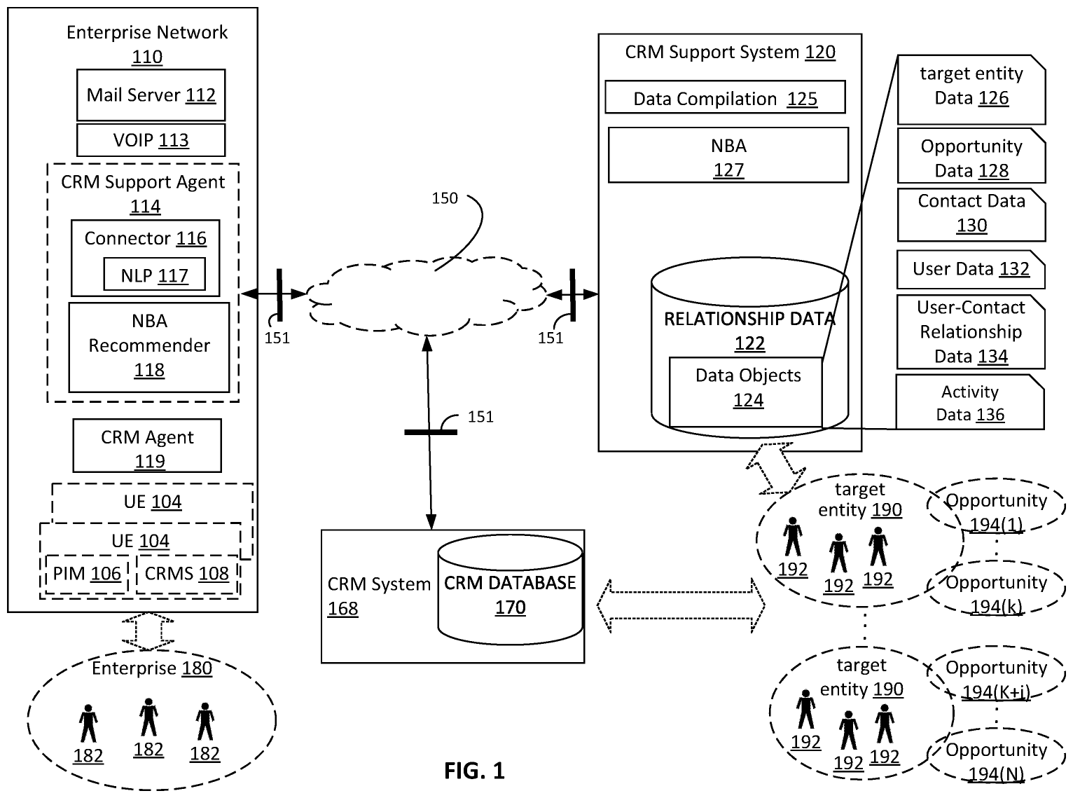

FIG. 1 illustrates an example of an automated computer-implemented environment in which the methods and systems described in this disclosure may be implemented. In the example of FIG. 1, the environment includes an enterprise network 110 that supports an enterprise such as a company, firm, government organization, charity or other type of organization (referred to in this disclosure as “enterprise 180”) that is pursuing one or more opportunities with one or more external entities. For example, an opportunity could include a process that involves selling or otherwise providing a product or service, or a process that involves signing up members or participants or obtaining funding. In example embodiments, a plurality of individuals are registered or otherwise associated with the enterprise network 110 as individual users 182 that are supported by the enterprise network 180. These individual users 182 may for example include employees, owners, partners, consultants, volunteers, and interns of the enterprise 180. In some examples, enterprise 180 could have as few as one individual user 182, and in some examples, enterprise 180 may have thousands or more individual users 182.

At any given time the enterprise 180 has, or is, pursuing commercial or other types of relationships with one or more external entities. For example, such external entities could be existing or potential customers, constituents, party members, clients or donors or other entities of interest to the enterprise, and may include, among other things, companies, partnerships, universities, firms, government entities, joint venture groups, non-government organizations, charities other types of groups, and individuals. As used here, “target entity” can, for example, refer to an external entity that the enterprise 190 has identified and is tracking information in relation to one or more opportunities. In example embodiments, external entities that are known to the enterprise 180 are registered in one or more databases of the enterprise as a respective customer or “target entity” 190. Typically, each target entity 190 will have an associated set of individual contacts, referred to in this disclosure as “contacts” 192. For example, the individual contacts 192 associated with a target entity 190 may be employees, owners, partners, consultants, volunteers, and interns of the target entity 190. Furthermore, at any given time the enterprise 180 will typically have completed or will be pursuing multiple opportunities 194(1) to 194(N) across multiple different target entities 190. In this disclosure, the reference “opportunity 194” will be used to refer an illustrative individual opportunity, and “opportunities 194” used to refer one or more opportunities in the group of opportunities 194(1) to 194(N). Opportunities 194(1) to 194(N) can include open and closed opportunities. An open opportunity can, by way of non-limiting example, refer to a commercial deal that the enterprise 180 “seller” is currently pursuing with respect to a target entity 190 “customer”. A closed opportunity can, for example, refer to a commercial deal that the enterprise 180 “seller” is no longer actively pursuing with respect to a target entity 190 “customer”, either because the deal has moved into a post sales stage through a successful closing or because a decision has been made that the deal cannot be successfully completed. Thus, an opportunity 194 may for example be a sales opportunity to sell a product or service, and has an opportunity lifetime that can be represented as an opportunity timeline (e.g., duration of time from recognition of existence of the opportunity to closing of the opportunity). The opportunity timeline can typically be divided into a set of successive stages or phases, at least some of which may overlap with or correspond to the basic stages of a sales cycle (e.g., (i) find leads (prospecting), (ii) connect, (iii) qualify lead, (iv) present, (v) overcome objections and (vi) close). In some examples, a specific opportunity may not be tracked as a discrete opportunity until it has reached a defined stage, for example a “qualified lead” stage. By way of example, a pre-lead qualification opportunity can overlap with sales cycle process stages (i) lead identification (prospecting), (ii) connection; and (iii), and (B) a “lead qualified” opportunity can overlap with sales cycle process stages (iv) presentation, (v) overcoming objections and (vi) closing.

Enterprise network 110 may, for example, include a plurality of computer devices, servers and systems that are associated with the enterprise 180 and are linked to each other through one or more internal or external communication networks, at least some of which may implement one or more virtual private networks (VPN).

In example embodiments, the environment of FIG. 1 also includes a CRM support system 120 and a CRM system 168, each of which may also include one or more computer devices, servers and systems. One or both of CRM support system 120 and CRM system 168 may, in some examples, be operated by third party organizations that are service providers to the enterprise 180 associated with enterprise network 110. CRM support system 120 and a CRM system 168 are configured to track customer data and other information on behalf of enterprise 180.

In the illustrated example, enterprise network 110, CRM support system 120, and CRM system 168 are each connected to a common communication network 150. Communication network 150 may for example include the Internet, one or more enterprise intranets, wireless wide area networks, wireless local area networks, wired networks and/or other digital data exchange networks. Respective firewalls 151 may be located between the communication network 150 and each of the enterprise network 110, CRM support system 120, and CRM system 168. In different example embodiments, one or more of the features, modules or functions of enterprise network 110, CRM support system 120, and CRM system 168 that are described herein could alternatively be implemented in common systems or systems within a common network. For example, some or all of the features or modules of one or both of CRM support system 120 and CRM system 168 could alternatively be hosted on one or more computer systems located within the enterprise network 110. Alternatively, in some examples, some or all or the agents, modules or systems included in FIG. 1 as part of enterprise network 110 could be remotely hosted (for example at CRM support system 120 or CRM system 168) and accessed by users 182 of the enterprise network 110 through network 150. The locations of various modules, engines, systems and databases as shown in FIG. 1 is illustrative of only one of many possible architecture configurations.

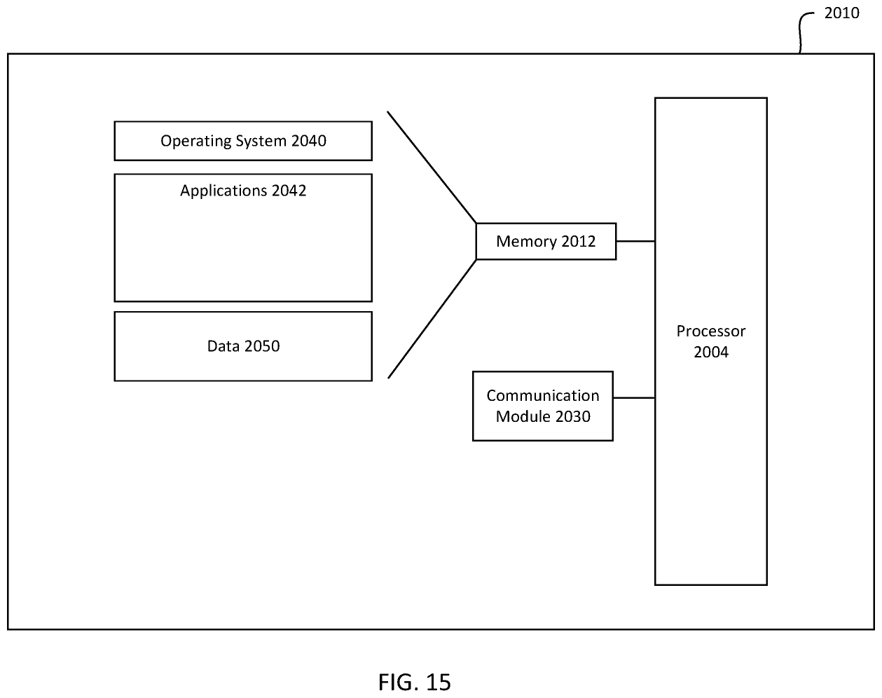

As used here, a “module” or “engine” can refer to a combination of a hardware processing circuit and machine-readable instructions (software and/or firmware) executable on the hardware processing circuit. A hardware processing circuit can include any or some combination of a microprocessor, a core of a multi-core microprocessor, a microcontroller, a programmable integrated circuit, a programmable gate array, a digital signal processor, or another hardware processing circuit. For example, a hardware processing circuit can include components of a computer system 2010 as described below in respect of FIG. 15. A database or data storage can refer to a collection of information that is stored in an electronically accessible format using a non-transitory storage medium.

Enterprise Network 110

Enterprise network 110 includes at least one mail server 112 for handling and delivering external email that enterprise network 110 exchanges with remote mail servers through communication network 150. Thus, mail server 112 handles external emails that are sent and received by the individual users 182 associated with enterprise network 110. In some examples, mail server 112 may also handle internal emails that are internal within the enterprise network 110.

In some examples, enterprise network 110 includes at least one voice over internet protocol (VOIP) system 113 handling internal and external telephone communications. VOIP system 113 may be configured to log information about incoming and outgoing calls, including phone numbers and associated participant identifying data, timestamp information regarding start and stop times. In some example's VOIP system 113 supports voice messaging that enables incoming messages to be recorded. In some examples, VOIP system 113 may enable incoming and outgoing calls to be recorded.

In example embodiments, enterprise network 110 includes a CRM agent 119 that provides the enterprise network 110 with an interface to CRM system 168.

In example embodiments, enterprise network 110 also includes a CRM support agent 114 that provides the enterprise network 110 with an interface to CRM support system 120. In example embodiments, CRM support agent 114 includes a connector 116 that functions as an interface module between components of the enterprise network 110 and the CRM support system 120. For example, connector 116 is configured to interact with systems within the enterprise network 110 (such as mail server 112, VOIP system 113 and user equipment (UE) devices 104) to extract information about events (such as communication events and other enterprise-target entity interaction events) and provide that information to CRM support system 120.

As will be described in greater detail below, in example embodiments, the CRM support agent 114 has access to (or includes selected functionality of) a Next Best Action (NBA) recommender module 118 that is configured to interact with a user 182 to provide, among other things, intelligent information about how an opportunity is progressing and recommend next best actions.

In example embodiments, enterprise network 110 supports a plurality of UE devices 104. Each enterprise user 182 is associated with one or more respective UE devices 104. In example embodiments, a UE device 104 may be a smartphone, computer tablet, laptop computer, desktop personal computer, wearable electronic device or other communication enabled computer device. In example embodiments, UE devices 104 are configured with a personal information manager (PIM) module 106. Among other things, the PIM module 106 includes an email client, as well as one or more other functions such as calendaring, task managing, contact managing, note-taking, journal logging, and web browsing functions. The PIM module 106 will typically store associated PIM data that includes, among other things, user calendar data, user address book data, user email data and user messaging data. Examples of PIM modules 106 include modules that support basic communications and scheduling services that the user of a UE device 104 is registered with, such as Google Gmail™, Microsoft Outlook Exchange Web Service, and/or Lotus Domino. In example embodiments, some or all of the PIM data associated with a user 182 may be stored locally on the UE device 104 associated with the user, and in some examples, all or parts of the PIM data may be stored at a remote server hosted by or for enterprise network 110 that is accessible through a communication network to the UE device 104. In various embodiments, some or all of the PIM data for users 182 that is stored at UE devices 104 or other remote server is accessible to CRM support agent 114. In some examples, one or more connectors 116 are associated with CRM support agent 114 to enable the CRM support agent 114 to periodically retrieve the PIM data of registered users 182.

In example embodiments, UE devices 104 each include a CRM support client 108 that is configured to interface with the connector 116 of CRM support agent 114 to support the systems and methods described herein, including the exchange of PIM data described above. In example embodiments, a user 182 may have multiple associated UE devices 104 across which PIM data is synchronized. In some examples, a UE device 104 associated with a user could be a virtual device (e.g., a user virtual desktop) that is hosted by a server within enterprise network 110 and accessed by a remote access device (e.g., a thin client device).

CRM System 168

In example embodiments, CRM system 168 may be implemented using a known CRM solution such as, but not limited to, Salesforce.com™, Microsoft Dynamics™, InterAction™ or Maximizer™, and includes a CRM database 170 that includes customer data (e.g., CRM data) for target entities 190 that are tracked by enterprise 180. The CRM data that is stored in a CRM database 170 for an target entity 190 may for example include: (I) general target entity data, (II) opportunity data about specific opportunities that the enterprise has undertaken in the past, is currently undertaking, or is proposing to undertake in the future with target entities 190, and (III) individual contact data that includes contact information for individual contacts who are members of the target entities 190.

CRM Support System 120

In example embodiments, CRM support system 120 is configured to provide enhanced CRM information and functionality that supplements CRM System 168, although in some examples the functionality of CRM support system 120 and CRM system 168 may be merged into a single system. CRM support system 120 includes a relationship database 122 for digital electronic storage of relationship data generated in respect of the target entities 190 of interest to enterprise 180. In example embodiments, relationship database 122 may store, in respect of each target entity 190 (e.g., each customer or client of enterprise 180), relationship data objects 124 that include: (I) target entity data 126 that provide general information about the target entity 190, (II) opportunity data 128 about specific opportunities that the enterprise has undertaken in the past, is currently undertaking, or is proposing to undertake in the future with the target entity 190, (III) individual contact data 130 that includes contact information for individual contacts 192 (e.g., employees) who are associated with the target entity 190, (IV) user data 132, that includes information about enterprise users 182 who are involved in the relationship with an target entity 190, (V) user-contact relationship strength data 134, (VI) activity data 136 that includes information about activity events that occur during the timeline of an opportunity that enterprise 180 is pursuing with target entity 190. At least some activity events that are tracked correspond to “actions” that are performed by the enterprise or enterprise users. The data in relationship database 122 may include some or all of the information stored at CRM database 170, as well as supplemental information. In some examples, relationship database 122 includes links or other references to data stored at CRM database 170.

Data Compilation Module 125

In example embodiments, the CRM Support System 120 includes a data compilation module 125 that interfaces with connector 116 of CRM support agent 114 and other possible data sources to collect, update and process data objects 124 stored in relationship database 122. In some examples, the data compilation module 125 is configured to automatically periodically refresh (e.g., for example on a timed cycle such as once every 24 hours) the content of data objects 124 such that the data maintained in relationship database 122 includes current or near-current information. The data compilation module 125 may periodically refresh the information stored in relationship database 122 based on information that is collected from a plurality of sources and transformed into a format suitable for use by one or more modules within the enterprise network 110 or CRM support system 120. For example, data compilation module 125 may obtain data from CRM support agent 114 of enterprise network 110, the CRM database 170 of CRM system 168, from sources within enterprise network 110, and from other data sources that are available through communication network 150. In some examples, one or more of the operations of data compilation module 125 may be manually triggered by a system administrator or user. In some examples, data compilation module 125 may process historic data as part of an onboarding process. Data compilation module 125 can transform data into a format that is suitable for efficient processing by modules included in the enterprise network 110 or CRM support system 120 of the environment of FIG. 1.

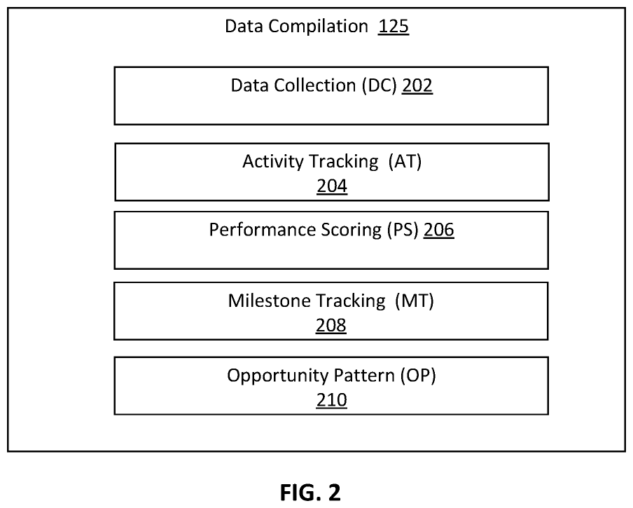

A non-exhaustive set of operations 202, 204, 206, 208, and 210 that may be performed on a scheduled or on-demand basis by the data compilation module 125 are illustrated in FIG. 2. These operations include a data collection operation (DC) 202, an activity tracking (AT) operation 204, a performance scoring (PS) operation 206, a milestone tracking (MT) operation 208, and an opportunity pattern generation (OP) operation 210.

In example embodiments, the CRM support system 120 includes both current and historic records in data objects 124, enabling changes in data, including data of the type included in the Tables 1 to 6 described below, to be tracked over time. For example, both current and historical time-stamped versions of records that include the data fields listed in Tables 1 to 6 may be stored as data objects 124 at relationship database 122.

The data included in data objects 124 in relationship database 122 may be obtained by the data compilation module 125 of CRM support system 120 from different sources using different methods. In an example embodiment, data compilation module 125 includes a data collection operation 202 for collecting information from CRM support agent 114, CRM system 168, and possibly other external sources on a scheduled or on-demand basis. For example, some information may be collected by data collection operation 202 from enterprise users 182 based on data entry provided through user interfaces supported by UEs 104 and/or CRM support agent 114. Some information may be gathered from third party data providers (e.g., contact information and target entity information pertaining to inactive prospective target entities and contacts, and supplementary information regarding contacts 192 and target entities 190). Some information may be gathered directly or indirectly (for example via CRM agent 119) from CRM system 168. Some information may be gathered through automated monitoring of enterprise network 110 events, including events at mail server 112 and UE device PIM 106 events such as email events, calendar events and contact management events. Data collection operation 302 may configure CRM support system 120 to perform scheduled periodic email, calendar and contact synchs with CRM support agent 114 for updates.

Operations 204 to 210 each process and transform data that is collected by data collection (DC) operation 202 to generate additional data that can be included in data objects 124. Operations 204 to 210 will each be described in greater detail below.

The following Tables 1 to 6 provide examples of variable data fields that may be included in data records that are maintained as data objects 124 in relationship database 124. At least some of the data stored as data objects 124 can generally be categorized as static (“S=static”) or dynamic (“D=dynamic”) variables. Static variables denote information that is expected to stay reasonably constant and not be largely impacted by events that occur over the duration of an opportunity. Static variables are typically categorical variables. Dynamic variables are expected to change over the course of an opportunity and are impacted by events (for example, events such as actions that are tracked as activity data 136) that occur over the duration of an opportunity. For example, dynamic variables can be based on temporal data that is collected over time. Dynamic variables are typically continuous variables. Even though consistency is generally expected in static variables, in at least some examples, static variables may change over time in respect of ongoing opportunities and will be updated accordingly.

Variables are identified as Static and Dynamic in the following Tables 1-6, and a column “Source Operation” is included to indicate which of the data compilation operations (e.g., raw data collection operation (DC) 202, activity tracking operation (AT) 204, performance scoring (PS) operation 206, milestone tracking (MT) operation 208, and opportunity pattern (OP) operation 210) may, in some examples, perform the collection or computation of the subject variable.

Target entity data 126: In example embodiments, the basic data included in target entity data 126 stored at relationship database 122 may include, for each target entity 190, data corresponding to some or all of the fields listed in the following Table 1, among other things:

TABLE 1
Target Entity Data Fields:

| Field (S = Static, | | Source |
|---|---|---|
| D = Dynamic] | Field Description | Operation |
| Enterprise ID (S) | Unique identifier assigned to Enterprise | DC 202 |
| | 180 | |
| Target entity ID (S) | Unique identifier assigned to Target | DC 202 |
| | entity 190 | |
| Target entity Industry | Code that identifies primary industry | DC 202 |
| Code (S) | type of customer organization (e.g., | |
| | Standard Industrial Classification (SIC) | |
| | Code and/or North American Industry | |
| | Classification System (NAICS) Codes) | |
| Number of Employees | Number of Employees of Target entity | DC 202 |
| (S) | Organization | |
| Target entity Size | Score or category bucket assigned | DC 202 |
| Score (S) | based on size of target entity | |
| | organization (e.g., organization size of | |
| | 1500 + employees = 10 points; 1000 to | |
| | 1500 = 9 points; 750-1000 = 8 points, | |
| | etc.; or 1-100 employees = Micro | |
| | entity; 101-500 Small/Medium | |
| | Enterprise (SME) entity; 501+ = Large | |
| | entity) | |
| Target entity Annual | Annual Revenue of target entity | DC 202 |
| Revenue (S) | organization for one or more previous | |
| | years | |
| Owner User ID (S) | User ID of enterprise user 182 who | DC 202 |
| | owns the target entity (e.g., user 182 | |
| | who has primary responsibility for | |
| | enterprise-target entity relationship) | |
| Target entity Name | Name of Target entity (e.g., company | DC 202 |
| (S) | or organization name) | |
| Target entity Source | Type of event that generated the | DC 202 |
| (S) | Target entity (e.g., investor referral, | |
| | partner referral, cross-sell, website | |
| | request, C-level connection, cold call) | |
| Region (S) | Geographic location(s) of the Target | DC 202 |
| | entity (e.g., buckets such as: North | |
| | America (NA); Europe, Middle East | |
| | and Africa (EMEA)'Asia Pacific | |
| | (APAC); Latin America (LATAM); | |
| | South America (SA)) | |
| Top User-Target | The enterprise user 182 that has the | PS 206 |
| entity Relationship | strongest relationship with the target | |
| (D) | entity 190 | |
| Target entity Status | Indicates Current Status of Target | DC 202 |
| Indicator (D) | entities being targeted (e.g., Current | |
| | Active Target entity with Open | |
| | Opportunity; Current Active Target | |
| | entity with no Open Opportunity; | |
| | Active target entity, Exploratory | |
| | Relationship; Inactive Target entity; | |
| | Inactive Target entity, prospecting) | |

Opportunity data 128: In example embodiments, the basic data included in opportunity data 128 stored at relationship data storage 122 may include, for each opportunity with target entity 190, opportunity records that include data that corresponds to some or all of the fields listed in the following Table 2:

TABLE 2
Opportunity Data Fields:

| Field (S = Static, | | Source |
|---|---|---|
| D = Dynamic] | Field Description | Operation |
| Opportunity ID (S) | Unique identifier assigned to | DC 202 |
| | Opportunity | |
| Target entity ID (S) | Target entity ID of the target entity | DC 202 |
| | that is the target of the opportunity | |
| Created Date (S) | Date opportunity registered with CRM | DC 202 |
| | support system | |
| Start Date (S) | Date opportunity deemed to be an | DC 202 |
| | “open” opportunity (may be same as or | |
| | different than created date) | |
| Closed Indicator (S) | Indicates if opportunity is closed | DC 202 |
| Closed Date (S) | Date Opportunity was closed | DC 202 |
| Stage Data (D) | Indicates current stage of open | MT 208 |
| | opportunity, and when prior stages | |
| | were completed (e.g., (i) find leads | |
| | (prospecting), (ii) connect, (iii) qualify | |
| | leads, (iv) present, (v) overcome | |
| | objections and (vi) close.) (May be | |
| | updated by an enterprise user and/or | |
| | automatically detected) | |
| Milestone data (D) | Indicates milestone events that have | MT 208 |
| | occurred during the opportunity and | |
| | when they occurred (e.g.: Milestone | |
| | events such as: (1) Detailed Demo; (2) | |
| | Buy-in from Lead Contact; (3) Timeline | |
| | Confirmed) (May be updated by an | |
| | enterprise user and/or automatically | |
| | detected) | |
| Won Indicator (S) | Indicates opportunity closed | MT 208 |
| | successfully or not (e.g., with a sale) | |
| Opportunity Size | Score that represents a size or dollar | DC 202 |
| Score (S) | value of the opportunity (e.g., could be | |
| | based on one or more of monthly | |
| | recurring revenue (MRR), annual | |
| | contract value (ACV) or total contract | |
| | value (TCV) | |
| Projected Budget (S) | Indicates projected budget of Target | DC 202 |
| | entity for opportunity | |
| Product/Service ID | ID(s) of products or services that | DC 202 |
| (S) | opportunity relates to | |
| Product/Service Units | Projected number of units of product or | DC 202 |
| (S) | service that opportunity will require | |
| Main Contact ID (S) | Contact ID of lead contact for | DC 202 |
| | opportunity with the target entity | |
| Decision Maker ID | Contact ID of perceived decision maker | DC 202 |
| (S) | at the target entity (May be same as or | |
| | different than Main Contact ID) | |
| Main User ID (S) | User ID of lead user for opportunity | DC 202 |
| Target entity Team | Contact IDs of all contacts participating | DC 202/ |
| (Purchasing Team) | in the opportunity, (can include | AT 204 |
| (D) | timestamp information indicating team | |
| | entry/exit) | |
| Enterprise Team | User IDs of all enterprise users | DC 202/ |
| (Selling Team) (D) | participating in the opportunity, (can | AT 204 |
| | include timestamp information | |
| | indicating team entry/exit) | |
| Opportunity | Value that indicates a momentum of | PS 206 |
| Momentum Score(D) | the opportunity (e.g., based on trends | |
| | in communication and events between | |
| | buying team and selling team) | |
| Multi-thread Score | Indicates current Multi-thread score, | PS 206 |
| Data (D) | and Multi-thread scores at times when | |
| | stages are completed and/or milestone | |
| | events have occurred. Multi-thread | |
| | score is indicative of a perceived | |
| | suitability of combined members of the | |
| | Target entity Teams and Enterprise | |
| | Teams that are participating in the | |
| | opportunity. | |
| Communication | One or more values that indicate a | PS 20; 6 |
| Quality Score (D) | qualitative value communication events | |
| | that have been occurring between the | |
| | buying and selling teams.(e.g., could | |
| | include a sentiment trend value that | |
| | indicates positive or negative | |
| | sentiments detected in communication | |
| | events between selling team and | |
| | buying team; a product value that | |
| | indicates number of times references to | |
| | products of the enterprise occur in | |
| | communication events between selling | |
| | team and buying team; a competitor | |
| | value that indicates number of times | |
| | references to a competitor, competitor's | |
| | products, and/or competitor product | |
| | features occur in communication events | |
| | between selling team and buying team. | |
| Enterprise Team | Value that indicates perceived strength | PS 206 |
| Score (D) | of the overall composition of the selling | |
| | team for the opportunity | |
| Target entity Team | Value that indicates strength of the | PS 206 |
| Score(D) | purchasing team | |
| Main User—Target | Score That Indicates Perceived strength | PS 206 |
| entity Team | of main users' relationship with | |
| Relationship Score(D) | members of the Target entity Team | |
| Main User—Decision | Score That Indicates Perceived strength | PS 206 |
| Maker Relationship | of main users' relationship with | |
| Score(D) | decision maker of the Target entity | |
| | Team | |
| Enterprise Team— | Score That Indicates Perceived strength | PS 206 |
| Target entity Team | of overall relationship selling and | |
| Relationship Score(D) | purchasing teams | |
| Sales Methodology | Can include other scores, for example | PS 206 |
| Features (D) | BANT (Budget-Authority-Need- | |
| | Timing) scores. | |
| Opportunity Pattern | One or more tensors of opportunity | OP 210 |
| Data (S or D) | attributes (e.g., static opportunity | |
| | feature vector Fs, described below, is | |
| | static opportunity pattern data) | |

Opportunity data 128 may be updated over time as the opportunity 194 progresses, with updates being timestamped. Initial information about an opportunity 194 may be initially provided by an authorized user 182 at the time that an opportunity 194 is opened. In some examples, data compilation module 125 may be configured to gather or infer missing data that is not provided by an authorized user 182 or to check or verify data that is entered. In some examples, an opportunity is created (assigned an opportunity ID and tracked in CRM system and/or CRM support system 120 as a discrete opportunity) once a lead is qualified in respect of a sales matter. In some examples, the “start date” for an opportunity may be deemed to be earlier than the creation date, for example when a user indicates that the opportunity was first identified. In some examples the “start date” for an opportunity may be deemed to be later than the creation date, for example when a user first starts actively pursuing a previously created, but dormant, opportunity. In some examples, the timing for creation and start dates can be based on other predefined criteria.

Contact Data 130 In example embodiments, the basic data included in contact data 130 stored at relationship data storage 122 may include, for each contact 192 at target entity 190, contact records that include data that corresponds to some or all of the fields listed in the following Table 3, among other things:

TABLE 3
Contact Data Fields:

| Field (S = Static, | | Source |
|---|---|---|
| D = Dynamic) | Field Description | Operation |
| Contact ID (S) | Unique contact identifier | DC 202 |
| Active/Inactive | Indicates if contact is active or | DC 202/ |
| Indicator (S) | inactive | AT 202 |
| Date Created (S) | Date contact added | DC 202 |
| Target entity ID (S) | Target entity ID of the target entity | DC 202 |
| | the contact is associated with (referred | |
| | to as “contact's target entity”) | |
| Department (S) | Name of contact's department in | DC 202 |
| | contact's target entity | |
| Department ID (S) | Numerical value that maps to | DC 202 |
| | Department (based on pre-defined | |
| | mapping rules) | |
| Target entity Industry | Industry Code for contact's target | DC 202 |
| Code (S) | entity | |
| Position/Title (S) | The position/title of the contact in | DC 202 |
| | contact's organization | |
| Title Score (S) | Hierarchal Score assigned to Contact | DC 202 |
| | based on contact's position at contact's | |
| | organization (e.g., may be defined by | |
| | a look up table that maps position | |
| | titles to scores: president = 20 points, | |
| | CEO = 20 points, VP = 18 points, | |
| | senior manager = 14 points; partner = | |
| | 16 points, etc.) | |
| Contact-Enterprise | Score That Indicates Perceived | PS 206 |
| Relationship Score | strength of the Relationship with the | |
| (D) | Contact | |
| First Name (S) | Contact's First Name | DC 202 |
| Last Name (S) | Contact's Last Name | DC 202 |
| Full Name (S) | Contact's Full Name | DC 202 |
| Primary Email (S) | Contact's Primary Email | DC 202 |
| Primary Phone (S) | Contact's Primary Phone | DC 202 |
| Preferred Marketing | Preferred Event Type for Contact (see | DC 202 |
| Event(S) | for example published US patent No. | |
| | US-2021-0089974 (Ser. No. | |
| | 17/027,492), incorporated herein by | |
| | reference) | |
| Contact Origination | Type and ID of event or events that | DC 202 |
| Type (S) | caused contact to be added as an | |
| | Active Contact (e.g., email | |
| | communication event, meeting | |
| | communication event, new outlook or | |
| | other personal information | |
| | management system contact addition) | |
| Image (S) | One or more images obtained from | DC 202 |
| | on-line sources (e.g., Linked-In ™ | |
| | profile picture) | |
| Opportunity ID(s) (D) | ID's of opportunities that the contact | DC 202/ |
| | is associated with | AT 204 |

As noted above, contacts can be indicated as active or inactive. In example embodiments, an active contact can be a contact that has been a party to an event (as tracked in activity data 136 below) within a predefined prior time period (e.g., last 18 months) and/or meets other pre-defined criteria including for example criteria as set by privacy and solicitation legislation or regulations. Inactive contacts are contacts that are not currently active and may in some examples be classified in one or more categories such as inactive historic contacts (e.g., contacts that were previously active contacts), and inactive prospective contacts (e.g., contacts working in industries that are of interest to the enterprise or with active target entities, but who are not historic contacts).

User Data 132: In example embodiments, the basic data included in user data 132 stored at relationship data storage 122 may include, for each user 182 that has a relationship with a contact 192 at the target entity 190, user records that include data that corresponds to some or all of the variable fields listed in the following Table 4, among other things:

TABLE 4
User Data Fields:

| Field (S = Static, | | Source |
|---|---|---|
| D = Dynamic] | Field Description | Operation |
| User ID (S) | Unique user identifier | DC 202 |
| Target entity ID | Target entity ID of the subject target | DC 202 |
| (S) | entity | |
| Department (S) | Name of user's department in the | DC 202 |
| | enterprise organization | |
| Title (S) | Title/position of user within enterprise | DC 202 |
| | organization | |
| User-Target entity | Score That Indicates Perceived | PS 206 |
| Relationship Score | strength of User's Relationship With | |
| (D) (*) | Target entity | |
| Opportunity ID | Opportunity ID for opportunity for | DC 202/ |
| (D) (*) | which user is member of the | AT 204 |
| | enterprise team (e.g., selling team) | |

*indicates fields that can be repeated for multiple target entities/opportunities

User-Contact Relationship Data 134: In example embodiments, the basic data included in user-contact relationship data 134 stored at relationship data storage 122 may include, for each user-contact relationship that exists between a user 182 within enterprise 180 and a contact 192 within the target entity 190, user-contact relationship records that include data that corresponds to some or all of the variable fields listed in the following Table 5, among other things:

TABLE 5
User-Contact Relationship Data Fields:

| Field (S = Static, | | Source |
|---|---|---|
| D = Dynamic] | Field Description | Operation |
| User ID (S) | Unique user identifier | DC 202 |
| Contact ID (S) | Contact Unique Identifier | DC 202 |
| Target entity ID (S) | Contact's Target entity | DC 202 |
| Start Date (S) | Date when relationship between | DC 202 |
| | user and contact started | |
| Relationship | Event ID and/or event ID of the | DC 202 |
| Origination | event/event that first triggered | |
| Indicator (S) | Contact/user relationship | |
| Active Indicator (S) | Indicates if relationship is | DC 202 |
| | currently active | |
| User-Contact | Score that indicates perceived | PS 206 |
| Relationship Score | strength of User-Contact | |
| (D) | Relationship Strength | |
| Last Event Date (D) | Date of last recorded event | AT 204 |
| | including user and contact | |

Activity Data 136: Activity data is by nature Dynamic as activity events occur over the course of an opportunity. In example embodiments, the activity data 136 stored at relationship data storage 122 may include data for activity events that are related to an entity-target entity relationship and opportunities related to that relationship. In examples embodiments, activity records are generated by activity tracking (AT) operation 204 based on data that is connected by data collection (DC) operation 202. For example, DC operation 202 may be configured to provide metadata and/or selected content data about communications passing through mail server 112 and/or VOIP 113 to enable activity tracking (AT) operation 204 to automatically identify trackable activity events and generate activity data 136 in respect of such activities. Activity events may for example include events such as communication events, documentation events, presentation events, and marketing events among other things. Activity data 136 may include respective event records for each logged activity.

By way of example, the enterprise network 110 based CRM support agent 114 may be configured to automatically collect information about communication events between users 182 associated with the enterprise 180 and external contacts 192 associated with a target entity 190. These communication events may for example be electronic communications such as email, meetings that are tracked in calendar systems and/or scheduled through email communications, and telephone calls that occur through a VOIP system that enables call logging. Each of these interactions have associated electronic data that includes a contact identifier (e.g., email address or phone number for contact 192), time stamp information for the interaction, and a user identifier (e.g., data that identifies the user(s) 182 of the enterprise 180 and target entity contacts 192 that were involved in the communication event).

In example embodiments, CRM support agent 114 is configured to collect the information about communication events by interacting with devices and systems that are integrated with enterprise network 110 and generate reports that are sent to CRM support system 120 automatically on a scheduled basis or when a predetermined threshold is met or a predetermined event occurs. In some examples, CRM support agent 114 may collect information from an enterprise mail server 112 and VOIP system located within enterprise network 110 and/or from PIM modules 106 associated with UE devices 104, via the connector 116.

In some examples, connector 116 may collect information from the mail server 112. For example, in some embodiments connector 116 is configured to intermittently run a batch process to retrieve email messages from the mail server 112 so that communication activity data can be derived from the email messages and provided through communication network 150 to the relationship database 122. In some examples, the connector 116 is configured to extract selected information from email messages as contact interaction data and other metadata. For each email message, the extracted information may for example include any external email address included in the sender, recipient and carbon copy (CC) and blind carbon copy (BCC) recipient email address fields, along with a send or receive timestamp applied to the email message by the mail server 112. In example embodiments, the extracted information can also include information that identifies any enterprise users 182 that are participating in the email as sender or recipient or CC/BCC recipient. In example embodiments, the extracted information can also include information that identifies any target entity members 192 that are participating in the email as sender or recipient or CC/BCC recipients.

In example embodiments, meeting requests and invites will be included among the email messages that are processed by mail server 112, and connector 116 is configured to include email addresses in the meeting invitee list and organizer fields in the contact interaction data extracted from the emailed meeting invite. In some examples, connector 116 may also be configured to interface with CRM support clients 108 to receive data from the PIM modules 106 of UE devices 104 associated with the enterprise network 110. In some examples where enterprise network 110 supports phone call logging, for example in Voice-Over-Internet-Protocol (VOIP) implementations supported by a VOIP system, connector 116 may be further configured to interact with a VOIP server to collect information such as metadata about external phone numbers used for outgoing and internal calls, and timestamp information, for inclusion in communication activity data.

In at least some examples, in addition to collecting metadata (e.g., information about participants, time stamps, etc.) about communication events, data collection operation 202 of CRM support system 120 may also collect substantive information. In some examples, that information could be the actual text of information that is included in electronic communications such as emails, text messages, calendar invites. In some examples, a speech to text conversion engine may be used to transcribe audio data from communication events such as phone calls, video conferences and voice mail messages that occur through enterprise network 110, and that text could be stored as part of the activity data.

In some examples, text from electronic messages or text obtained from verbal communication transcriptions may be analyzed and abstracted using an natural language processing (NLP) module 117 that has been trained or otherwise configured to generate vector embeddings that indicate content of interest (including for example, embeddings that represent one or more of word level content, phrase level content, word grouping topical content and/or a sentiment). In some examples, for security or other reasons, such NLP embedding may be performed at the enterprise network 110. For example, connector 116 may include an NLP module 117 that is configured to generate embeddings in respect of electronic and audio communications events and provide that information to CRM support system 120. Among other things, NLP module 117 can perform filtering, text classification and sentiment analysis functions that can enable the substantive content of communications events to be represented as numeric tensors that can be processed using automated solutions. In some examples, NLP module 117 may be configured to detect the occurrence of different types of activity events and milestone events based on the content of communications events, and that information can be used by one or more operations of the data compilation module 125 to populate and/or process activity data 136.

Activity data 136 may include time stamped event records that may include, depending on the type of event and availability of information, variables that correspond to the fields listed in the following Table 6, among other things:

TABLE 6
Activity Data Fields CD]:

| Field | Field Description |
|---|---|
| Event ID | Unique identifier assigned to event |
| Target entity ID* | Identity of Target entity whose contacts |
| | participated in the event |
| Opportunity ID* | Identity of the opportunity(ies) that |
| | event related to (May for example be |
| | the same as Target entity ID, |
| | determined based on external email |
| | domain for example, or could |
| | alternatively be deduced by activity |
| | tracking operation 204 based on one or |
| | more of participant User IDs) |
| Organizer ID | User ID of enterprise user that |
| | organized event (e.g., email sender or |
| | meeting organizer) |
| Event Type Indicator | Value that identifies the type of |
| | enterprise-target entity interaction |
| | event (e.g., (i) communication event: |
| | incoming email, outgoing email, |
| | incoming meeting request/calendar |
| | invite, outgoing meeting |
| | request/calendar invite, incoming |
| | phone call, received voicemail message, |
| | outgoing phone call, in-person meeting, |
| | outgoing voicemail message, virtual |
| | meeting, combination of in-person and |
| | virtual meeting; (ii) documentation |
| | event: proposal submitted, draft |
| | statement of work (SOW) submitted; |
| Field | Field Description |
| | final SOW submitted; contract |
| | submitted for review). |
| Action Event Indicator | Indicator that indicates if activity is an |
| | Action Event (e.g., event corresponds |
| | to an action taken by enterprise |
| | user(s)) |
| Document ID | ID of document template (can be used |
| | to identify content of standard form |
| | email in the form of a communication |
| | action, or to identify document |
| | template in case of documentation |
| | event) |
| Event Time | Date/time stamp for event (e.g., |
| | sending time stamp for outgoing email; |
| | can be start time in the case of an |
| | event that has a duration) |
| Event Duration and/or End | Duration of event (e.g., length of |
| Time (If applicable) | meeting or phone call), or data and |
| | time stamp indicating end of event |
| NLP Embeddings | Embeddings extracted from |
| | communication events |
| Sentiment Indicator | Indicator provided manually or by |
| | natural language processing algorithm |
| | as to sentiment of event (e.g.: negative |
| | to positive sentiment on scale of 1 to 5, |
| | in example embodiments, may be |
| | determined at CRM support agent 114 |
| | and sent by connector 116 to data |
| | compilation module 125) |
| Field | Field Description |
| Content Count* | Counts number of occurrences of |
| | predefined words in communication |
| | event (e.g., product name, competitor |
| | product name). (In example |
| | embodiments, may be determined at |
| | CRM support agent 114 and sent by |
| | connector 116 to data compilation |
| | module 125) |
| Participants—Target entity* | Contact IDs or other available identifier |
| (ID/Title/Department) | and title/department information for all |
| | individuals involved on target entity |
| | side who were invited |
| Participants—Enterprise* | User IDs or other available identifier |
| (ID/Title/Department) | and title/department information for all |
| | individuals involved on enterprise side |
| | of event |
| Subject | e.g., Information included in email |
| | Subject fields or meeting ″Subject″ field |
| | by meeting organizer. |
| Location | e.g., Information included in meeting |
| | ″Location″ field by meeting organizer |
| Additional Information | Additional descriptive information about |
| | event (e.g., information included in the |
| | open format field of a meeting |
| | scheduling form) |
| Average Enterprise—Contact | Average Enterprise-Contact |
| Relationship Score | Relationship Score of Target entity |
| | participants |
| Average Title Score | Average Title score of Target entity |
| Field | Field Description |
| | participants |
| Top Title Score | Top Title score among Target entity |
| | participants |

*Indicates fields that will be repeated as required

In some example embodiments, the extracted information could include additional information from the email such as contact information embedded in the email body, and in this regard, a data scrapping function such as that described in U.S. patent application Ser. No. 16/907,998 filed Jun. 22, 2020, entitled “System and Method for Identifying and Retrieving Signature Contact Information from an Email or Email Thread”, incorporated herein by reference, may be applied to retrieve such information. For example, such a system may also extract additional contact information such as name, title, phone number, social media links, and company name from an email message, for inclusion as part of the contact data 130.

Opportunity Timeline (TL)

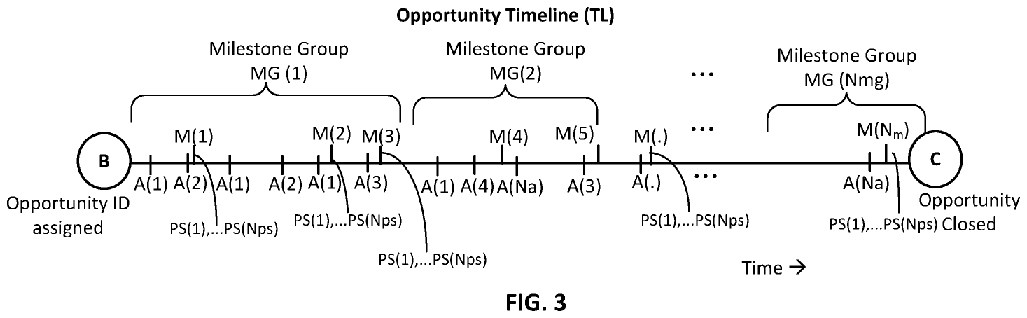

With reference to FIG. 3, CRM support system 120 is configured to process each opportunity 194 as a discrete temporal episode that takes place over a respective opportunity timeline (TL) that has a beginning and an ending. In some examples, the opportunity timeline TL for an opportunity can, for example, begin when the opportunity 194 is allocated a unique opportunity ID in the CRM support system 120 and end when the opportunity is closed, either with a win (e.g., a sale occurs) or a loss (e.g., a decision is made to stop pursuing the opportunity as an open opportunity as no sale is likely to occur).

In example embodiments, the opportunity timeline TL is considered as a set Sm of milestones M(1) to M(Nm) that are either achieved or not achieved during the course of an opportunity 194. In examples, Milestone events M(1) to M(Nm) are predefined events that can indicate that an opportunity is moving towards a successful close and can be influenced by actions of enterprise 180 or actions of an target entity 190. By way of illustrative examples, defined milestone events may include, among other things: M(1): target entity user 192 indicates interest; M(2) target entity user requests pricing information; M(3): first participation of target entity user 192 with decision making authority; M(i) product demonstration occurs; M(j) target entity user 192 confirms a purchasing timeline; M(k): draft contract requested; M(I) target entity legal department becomes involved; M(Nm): Contract executed.

Example embodiments are based on the premise that enterprise 180 and enterprise users 182 can influence the likelihood of milestone events occurring by performing one or more actions that are selected from a defined set Sa of candidate actions A(1) to A(Na). The set Sa of candidate actions A(1), . . . , A(Na) may for example include communications events and other activity events that the enterprise 180 and enterprise users 182 can instigate or participate in. By way of example, actions A(1), . . . A(Na) may include: A(1): outgoing email from enterprise user to one or more target entity users; A(2): outgoing calendar invite to one or more target entity users; A(3): videoconference with one or more target entity users; A(i): in-person meeting with one or more target entity users; A(Na)): in-person meeting with target entity users having a title score that exceeds a defined threshold; etc. Historic actions are tracked as part of the activity data 136 that is collected and stored in respect of opportunities 194 with target entities 190

As indicated in FIG. 3, one or more of instances of each of the candidate actions can occur in a period leading up to a milestone event M(.). For example, in FIG. 3, instances of actions A(1) and A(2) occur prior to milestone event M(1), and can be perceived as actions that contributed to the occurrence of milestone event M(1); Two instances of action A(1) and one occurrence of action A(2) occur after milestone event M(1) and prior to milestone event M(2), and can be perceived as events that contributed to the occurrence of milestone event M(2).

The timelines TL for different opportunities 194 may vary in that in some successfully closed opportunities some of the milestones included in the set Sm of milestones M(1) to M(Nm) may not be achieved in the same order, or in some cases, not at all. Furthermore, the same milestone in different opportunities may be achieved from different types and quantities of actions, performed in different orders. Thus, at the level of individual actions and milestones, the timelines TL for different opportunities can be relatively stochastic. Typically, however, at a macro-level, opportunities 194 will advance through a generally common set of stages or phases, which are indicated in FIG. 3 as milestone groups MG(1) to MG(Nmg). Although these milestone groups may in some examples correspond to the basic stages of a sales cycle according to known sales cycle models, in at least some examples they are determined independently of the traditional sales cycle stages through analysis based, for example, on historic data collected in relationship database 122. As indicated in FIG. 3, each milestone group MG(1) includes one or more respective milestones. For example, milestone group MG(1) includes milestones M(1) to M(3).

In example implementations, predefined reference opportunity timeline (Reference OTL) is stored at one or both of the CRM support agent 114 and the CRM support system 120. In one example, the Reference OTL is an ordered set of milestones M(1) to M(Nₘ) that is arranged in an expected order of occurrence. A predefined set of dynamic variables, for example, performance scores PS(1) to PS(Nps), are associated with each respective milestone M(1) to M(Nₘ). Further, subsets of milestone M(1) to M(Nₘ) can be assigned to defined milestone groups MG(1) to MG(Nmg). Although the milestones M(1) to M(Nₘ) of the Reference OTL are arranged in an expected order of occurrence, as described in greater detail below, the milestones within a particular milestone group for a current opportunity can in practice occur in an order other than set out in the Reference OTL. Further, some milestones may be skipped in the case of a current opportunity.

Performance Scoring Operation

In order to provide meaningful data that can be processed using automated, computerized processes, a series of performance scoring operations are performed by one or more modules to transform collected data into representative standardized attributes that can be compared across contacts, entities, and/or opportunities. For example, these standardized attributes can take the form of “performance scores”.

Accordingly, in example implementations, at least some of the dynamic variables represented in the above tables are performance scores generated by performance scoring operation 206. As will be explained in greater detail below, at least some of these performance scores are based on the activity data 136 generated by activity tracking operation 204. The performance scores can function as abstracted or coarse indications of the actions that are taken by one or both of the enterprise 180 (and users 182) and the target entity 190 (and users 192) during the course of an opportunity. In this regard, performance scoring operation 206 may include one or more scoring models for computing a set of performance scores PS(1), . . . , to PS(Nps). Some of the scoring models may be rules based. Some may be machine learning based models that have been trained using supervised learning. The scoring models are each respectively configured to transform collected data into a usable and representative standardized variable that can be processed using a computerized platform that incorporates one or more of the modules of the environment of FIG. 1.

Dynamic performance scores PS(1), . . . , to PS(Nps), computed by performance scoring PS operation 206, may include the following scores identified in Tables 1 to 5 above: Target entity data 126 (Table 1) includes: a “Top User-Target entity Relationship” that identifies the enterprise user 182 that has a highest overall relationship score with the subject target entity 190; contact data 130 (Table 3) includes a “Contact-Enterprise Relationship Score” that that indicates a perceived strength of the relationship of enterprise 180 with the subject contact 192; user data 132 (Table 4) includes a “User-Target entity Relationship Score” that indicates perceived strength of user's relationship with contact; and user-contact relationship data (Table 5) includes a “User-Contact Relationship Score” that indicates perceived strength of the user-contact relationship. Opportunity data 128 (Table 2) includes: an “Opportunity Momentum Score” that indicates a momentum of the opportunity (e.g., based on trends in communication and events between buying team and selling team); one or more “Multi-thread Score(s)” that indicates if the right depth and breadth of individuals are included in the buying and selling teams and in communication events between such teams, one or more “Communication Quality Score(s)” that indicate a qualitative value of communication events that have been occurring between the buying and selling teams, an target entity team score, an enterprise team score; and a number of Relationship Scores.

According to example embodiments, performance scoring PS operation 206 is configured to apply a set of score prediction models for computing a respective set of dynamic score variables when updating the data objects 124. In at least some examples, these dynamic score variables are calculated based on communication events between enterprise users 182 and target entity contacts 192, such as the communications events that are tracked as part of activity data 136. By way of example, the user-contact relationship score for an enterprise user 182—target entity contact 192 could be based on a communication score that is based on features such as, among other things: event type (e.g., incoming email, outgoing email, incoming meeting request/calendar invite, outgoing meeting request/calendar invite, incoming phone call, outgoing phone call, in-person meeting, on-line meeting, video conference); frequency (e.g., number of communication events with a defined time period); recentness of communication events; and length of communication event.

By way of illustrative non-limiting example, a contact-user communication score based on frequency of communication, recentness of communication, and type of communication could be determined based on a pre-defined model or algorithm such as follows:

Raw communication score=(total number incoming emails in last week from contact listing user as direct recipient)*(W1)+(total number outgoing emails in last week from user listing contact as direct recipient)*(W2)+(total number incoming emails in last week from contact listing user as CC recipient)*(W3)+(total number outgoing emails in last week from user listing contact as CC recipient)*(W4)+(total number of phone calls,in-person meetings, and virtual meetings involving both user and contact in last week)*(W5)+(total number incoming emails in last month from contact listing user as direct recipient)*(W6)+(total number outgoing emails in last month from user listing contact as direct recipient)*(W7)+(total number incoming emails in last month from contact listing user as CC recipient)*(W8)+(total number outgoing emails in last month from user listing contact as CC recipient)*(W9)+(total number of phone calls,in-person meetings, and virtual meetings involving both user and contact in last month)*(W10)+(total number incoming emails in last 6 months from contact listing user as direct recipient)*(W11)+(total number outgoing emails in last six months from user listing contact as direct recipient)*(W12)+(total number incoming emails in last 6 months from contact listing user as CC recipient)*(W13)+(total number outgoing emails in last six months from user listing contact as CC recipient)*(W14)+(total number of phone calls,in-person meetings, and virtual meetings involving both user and contact in last week)*(W15)+(total number of all communications events involving both user and contact over lifetime of user-contact relationship)*(W16)

Where: W1 to W16 are predetermined weights. (e.g., W1=W2=7; W3=W4=3; W5=8; W6=W7=5; W8=W9=2; W10=6; W11=W12=3; W13=W14=1; W15=4; W16=1).

It will be noted that the above example of the Raw Communication Score enables different types of communication events to be weighted differently, more recent communication events to be rated differently than older communications events, and different types of participation (e.g., sending party, direct “TO” field recipient, or “CC” field recipient in the case of email) to be weighed differently. In some examples, weighting could also be applied based on the number of participants in each communication event. This enables these factors to be given different levels of importance when determining relationship strength.

The particular equation shown above is illustrative and can be varied in different examples. In some applications, some of the communication events noted above may be omitted or combined, among other possibilities. The Raw Communication Score enables data that is automatically collected over a duration of time to be transformed to a standardized representative dynamic variable that is indicative of characteristics of the on-going communications between a specific contact-user pairing. The Raw Communication Scores that are computed in respect of different contact-user pairs transform automatically collected data into data that can be processed by a computing system to benchmark, compare and evaluate using automated methods.

In some examples, the weights may be manually set, and in some examples, the weights may be learned using a linear regression machine learning based model. In example embodiments, the communication score may be determined using a learned model that has been trained using machine learning techniques based on historic communication and relationship data.

In example embodiments the raw communication score may be normalized to a communication score based on comparison with historical data and/or data for other user-contact relationships or other scaling methodology to a range (for example 0 to 1). In some examples, the normalization may be based on data limited to the enterprise. In some examples, the normalization may be based on data from an industry. In some examples, normalization may be related to a specific target entity.

In some examples a User-Contact Relationship Score could be a composite of the contact's title score and a communication score based on the above attributes (e.g., contact title score*communication score). In some examples the User-Contact Relationship Score may be decided based only on the communication score. In some example embodiments, User-Contact Relationship Score could be represented as a discrete ranking within a relative scale such as “3=high”, “2=medium”, “1=low”.

In some examples, “Contact-Enterprise Relationship Score” could be based on a combination (e.g., sum or product) of all of the individual User-Contact Relationship Scores that a contact 192 has with users 182 of enterprise 180. In some examples, a “User-Target entity Relationship Score” could be based on a combination (e.g., sum or product) of all of the individual User-Contact Relationship Scores that a user 182 has with target entity contacts 192. In some examples, the “Contact-Enterprise Relationship Score” could be based on a combination of all the individual User-Contact Relationship Scores across all user-contact relationships between an enterprise 180 and a target entity 190. A “Main User—Target entity Team Relationship Score” could be based on a combination (e.g., sum or product) of all of the individual User-Contact Relationship Scores that a main user 182 (enterprise lead) has with target entity contacts 192 that make of the Target entity team (purchasing team) in respect of an opportunity. A “Main User—Decision Maker Relationship Score” could be the individual User-individual Contact Relationship Score between the main user 182 (enterprise lead) and the individual decision maker on the Target entity side for an opportunity. Enterprise Team-Target entity Team Relationship Score could be based on a combination (e.g., sum or product) of all of the individual User-Contact Relationship Scores that cover all of the users/contact pairs that make up the Enterprise team and Target entity team in respect of an opportunity. In some examples, the “Opportunity Momentum Score” may be based on trends over time in the metrics represented in the raw score calculation noted above, or and/or other communication trends. In this regard, Opportunity Momentum Score can embed communication trends. By way of example, a score model for generating an Opportunity Momentum Score could be configured to generate a score that is between 0 (minimum momentum score) and 1 (maximum momentum score based on the following input data curated from the data objects 124 in respect of a defined time period: (i) Incoming Emails: Average number of weekly incoming emails relating to Opportunity (e.g., from Target entity to Enterprise); (ii) Outgoing Emails: Average number of weekly outgoing emails relating to Opportunity (e.g. from Enterprise to Target entity); (iii) Ratio of Incoming to Outgoing Emails; (iv) Enterprise Email Response Time: Average Time to respond to incoming email from Target entity; (v) Target entity Email Response Time: Average Time for Target entity to respond to email from Enterprise; (vi) Number of Virtual Meetings relating to Opportunity: Average number of weekly meetings with Enterprise by phone or video conference; (vii) Number of In-Person Meetings relating to opportunity: Average number of weekly meetings with Enterprise in-person.

In some examples, various momentum scores can be calculated that reflect trends in each of the relationship scores identified above. For example, the computed Enterprise Team-Target entity Team Relationship Score can be tracked over the course of an opportunity to identify upward and downward trends, as well as to provide comparison data for other opportunities.

In some examples the “Multi-thread Score” could be computed by a multi-thread model that is configured to calculate multi-thread scores in respect of opportunities 194. In example embodiments, the multi-thread score is numeric value that scores the collective group of target entity contacts 192 and enterprise users 182 that are associated with an opportunity 194(j) (hereinafter the “opportunity team”). In some examples, the multi-thread score may be based on a combination of at least two of: the number of contacts 192 and users 182 associated with an opportunity; the titles of such contacts 192 and users 182; the departments of such contacts 192 and users 182; and one or more of the relationship scores relating to such contacts 192 and users 182. The model may be configured to give a higher score for title and departmental diversity within the opportunity team.

In a non-limiting example embodiment, multi-thread model 123B may apply a model that includes the following function to calculate a base multi-thread score: BASE MT Score=(SUM of Contact-Enterprise Relationship Scores for all contacts that are members of the Target entity Team)*(Wt1) PLUS (SUM of Contact-Enterprise Relationship Scores for all contacts that are members of the Enterprise Team)*(Wt2).

In some examples, the BASE MT Score may then be adjusted to account for title and departmental diversity as follows: ADJUSTED MT Score=BASE MT Score*(Wt3)+(number of different target entity-side departments included in opportunity)*(Wt4)+(number of different title scores included within each target entity-side department included in opportunity)*(Wt5)+(number of different enterprise-side departments included in opportunity team)*(Wt6)+(number of different title scores included within each enterprise-side department included in opportunity)*(Wt7). Where: Wt1 to Wt7 are predetermined weights that have either been manually set or have been learned using machine learning techniques.

It will be noted that weighting for the type of participation (e.g., sending party, listed in “TO” field, listed in “CC” field in the case of email) of users and contacts is embedded in the Raw Communication Score used as the basis for relationship scoring, and thus is among the factors accounted for in the BASE and ADJUSTED MT Scores. However, in some examples, further factors can be included into the equation for the ADJUSTED MT Scores to allow additional weight based tuning of the scores to account for the different types of participation by Target entity and Enterprise team members.

In some examples, the BASE MT Score may be calculated based on a sum of all the user-contact relationship scores for user-contact pairs in the opportunity team, rather than or in addition to overall user-target entity and contact-enterprise relationship scores.

In example embodiments, Multi-thread Score Data for each opportunity can include a set of scores that includes current BASE and ADJUSTED MT Scores, as well as historic BASE and ADJUSTED MT Scores that have been calculated at the completion of stages and milestones of the opportunity.

In some examples, Communication Quality Score(s) for an opportunity 194 may be computed by a Communication Quality Score model that is configured to generate a qualitative value of communication events that have been occurring between the buying and selling teams for a defined duration (e.g., the same duration as the Opportunity momentum score). The Communication Quality Score may be determined based on information received from NLP module 117, and may for example be based on one or more of: a sentiment trend value that indicates positive or negative sentiments detected in communication events between selling team and buying team; a product value that indicates number of times references to products of the enterprise occur in communication events between selling team and buying team; and a competitor value that indicates number of times references to a competitor, competitor's products, and/or competitor product features occur in communication events.

In some examples, Enterprise Team Score for an opportunity 194 may be computed by a respective model that indicates strength of the selling team. For example, such a score could be similar to the multi-threading score computation noted above, but be performed only from the perspective of the enterprise team. In some examples, the Enterprise Team Score may be based on past successes of one or more selling team members in respect of prior opportunities either with the same target entity or with past opportunities that have a similar Opportunity Pattern, or both. Similarly, Target entity Team Score for an opportunity 194 may be computed by a respective model that indicates strength of the selling team, and such a score could be similar to the multi-threading score computation noted above, but be performed only from the perspective of the target entity team. In some examples, the Target entity Team Score may be based on the composition of the buying team in respect of prior opportunities with similar target entities (e.g., based on similar opportunity patterns) that have been closed successfully.

Further examples of relationship scoring techniques that can be applied are described in U.S. Pat. No. 9,633,057, issued Apr. 25, 2017, the content of which is incorporated herein by reference.

In some example embodiments, current and historic values of dynamic performance score variables are included in the data objects. In some examples, historic values of dynamic score variables are included in the data objects. For example, a set of dynamic score variables can be stored as part of (or mapped to) the milestone data for an opportunity defined milestone events are achieved in respect of an opportunity.

Accordingly, referring again to opportunity timeline TL of FIG. 3 each milestone can include a set of respective opportunity performance scores PS(1), . . . PS(Nps) that can be indicative of the activities in a defined period leading up to the achievement of the milestone.

Milestone Tracking Operation

Referring again to FIG. 2, milestone tracking MT operation 208 is configured to automatically detect and track the occurrence of at least some milestones during the course of an opportunity 194, and to update the stored “Milestone data” of the opportunity data 128 for the opportunity 194 accordingly. As noted above, milestones M(1) to M(Nm) are predefined events. Detecting the occurrence of such events can enable the progression of a current opportunity 194 to be mapped to the reference opportunity timeline (Reference OTL).

In one example embodiment, the milestone tracking MT operation 208 may be configured to detect the occurrence of a milestone based on the activity data 136 that is generated by activity tracking (AT) operation 204 in respect of an opportunity 194 with a target entity 190. In some examples, milestone tracking MT operation 208 may be a sub-component of activity tracking (AT) operation 204. In some examples, the NLP module 117 located at CRM agent 114 may be configured to detect content of communications events that indicates the occurrence of milestone, and provide notification of such to the milestone tracking operation 208. In this regard, the NLP module 117 may include a milestone sub-module that is configured to identify and categorize content of electronic messages that is indicative of completion of a milestone M(1) to M(Nm). By way of example, the milestone sub-module could be a machine learning based NLP sub-module that is configured to detect language in an electronic message or transcribed from an audio file (e.g., obtained from a voice message or VOIP call) that is indicative of the occurrence of a milestone from a set of candidate milestone categories (i.e., milestones M(1) to M(Nm)). In this regard, the milestone sub-module could be configured to map language embeddings derived from an electronic message (or transcribed speech data) to one of the following milestone categories: M(1): target entity user 192 indicates interest; M(2) target entity user requests pricing information; M(3): first participation of target entity user 192 with decision making authority; M(i) product demonstration occurs; M(j) target entity user 192 confirms a purchasing timeline; M(k): draft contract requested; M(I) target entity legal department becomes involved; M(Nm): Contract executed; and NULL: no milestone indicated.

In some examples, the milestone categorization M(1) to M(Nm), or Null, determined in respect of an electronic messaging or transcribed speech activity can be added to the activity data 136 (e.g., as part of Table 6) that is stored in respect of the activity.

In some examples, milestone tracking operation 208 may employ one or more rules based and/or machine learning based models that processes selected data included in the data objects 124 to detect and track the occurrence of milestones M(1) to M(Nm) in respect of an opportunity 194

In some examples, milestones may be recorded based on manual inputs by enterprise users at UEs 104, received by CRM support system 120 through CRM support agent 114.

A further example of tracked-activity based milestone identification and tracking is disclosed in U.S. patent application Ser. No. 17/666,521, filed Feb. 7, 2022, “System and Method of Processing Data from Multiple Sources To Project Future Resource Allocation”, the contents of which are incorporated herein by reference.

Opportunity Pattern Operation

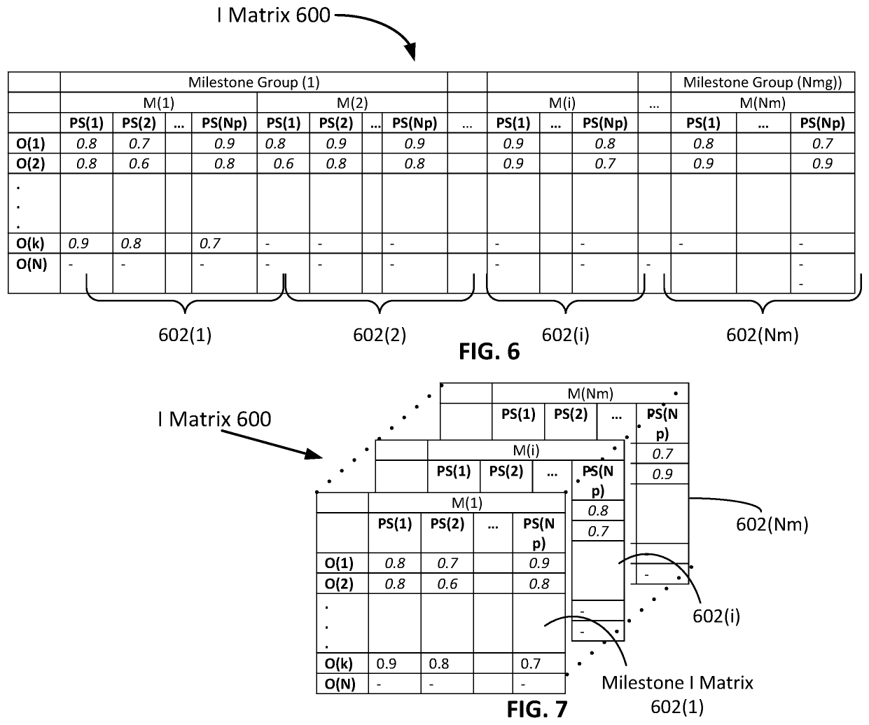

Referring to FIG. 2, in an example embodiment, data compilation module 125 includes an opportunity pattern operation 210 that is configured to generate a respective opportunity pattern for each opportunity 194. The opportunity patterns are intended to allow similar opportunities 194 to be identified based on an ordered set (e.g., a feature vector FV) of the static variables of the opportunities 194 and the target entities 190 that the opportunities are associated with. Examples of static target entity and opportunity variables are indicated above in Tables 1 and 2, denoted with an “(S)”. As noted above, static variables denote information that is expected to stay reasonably constant and not be significantly impacted by events that occur over the duration of an opportunity. By way of example, a static categorical variable may be a variable that is expected to be consistent for a duration of at least 2 months, and a static continuous variable may be a variable that is not expected to change by greater than plus/minus 10% within a duration of less than 2 months. A set of at least some of these static opportunity variables are selected for inclusion as static variables SF(1), SF(Ns) in a static feature vector FV to represent each opportunity 194. For example, the feature vector FV(1) for opportunity O(1) in the matrix of FIG. 6 will comprise the first row of static variables SF(1), SF(Ns). As the feature vector FV for each opportunity is based on static variables, it will typically remain the same for an opportunity once calculated and need not be updated unless a change occurs one of the feature variables.

Opportunity variables are typically categorical (either ordinal or nominal) and preprocessing may be applied to collected data to compute appropriate variables; e.g., data transformation processing to convert continuous variables to categorical. To ensure that these categorical variables can be consumed by system models, categorical variables can be encoded to numerical values while maintaining either the ordinal or nominal nature of the underlying data. By way of example, in one embodiment, one or more of the following static variables from the above Tables 1 and 2 may be represented using or more respective static variables SF(1), SF(Ns): Target entity ID; Target entity Industry Code; Target entity Size Score; Target entity Annual Revenue; Region; Target entity Source; Opportunity Size Score; Projected Budget; Product/Service ID; Product/Service Units; Main Contact ID; Main User ID. Thus, each static variables SF(1), SF(Ns), relates to a different feature that numerically represents a unique attribute (property) or set of attributes (properties) of the opportunity 194. In example embodiments, the pattern generation module 121 can be preconfigured with respective functions for generating one or more of the respective static variables SF(1), SF(Ns).

Next Best Action Module 127

As noted above, the presently disclosed methods and systems are based on the premise that although each opportunity 194 can be unique, patterns of actions that have proven successful in achieving milestones in historic opportunities can provide guidance that can increase the success of achieving milestones in current, similar, opportunities.

In this regard, CRM support system 120 includes a computer implemented next best action (NBA) module 127 that is configured to generate feedback that can be provided through NBA recommender 118 to a user 182 that is involved with an opportunity (e.g. an open opportunity 194(o)). As noted above, in example embodiments, the CRM support agent 114 may include NBA recommender 118, which is configured to interact with NBA module 127 and the UE 104 associated with a user 182 to provide, among other things, intelligent information about how an opportunity is progressing and recommended next best actions.

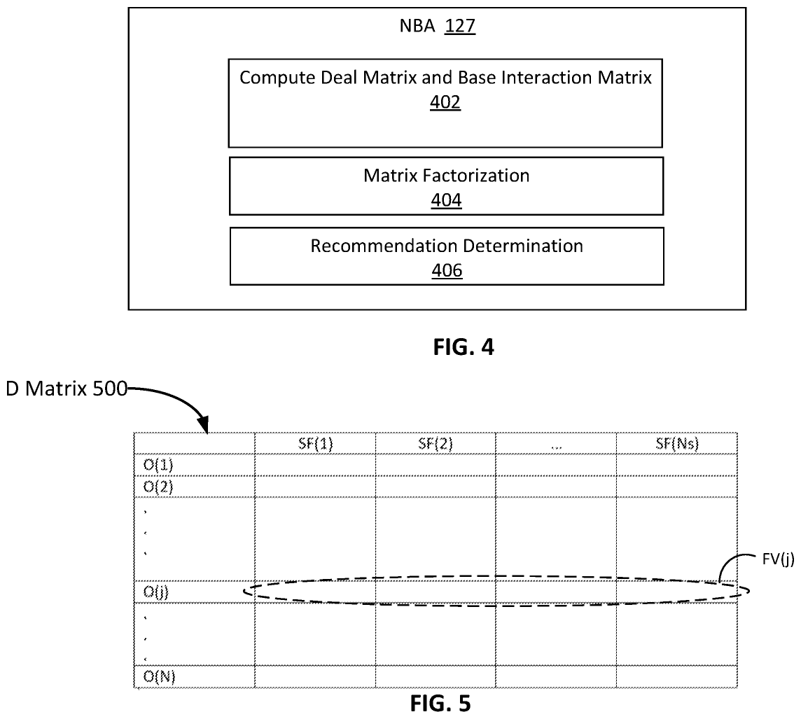

FIG. 4 illustrates a set of operations 402 to 406 that can be performed by NBA model 127 to generate recommended next best actions for ongoing opportunities. The operations 402-406 are based on data collected and processed by the various operations of data compilation module 125 and can be automatically performed at scheduled intervals (for example, after each periodic update of data objects 124 performed by data compilation module 125), or may be performed in response to a user request. Operations 402 to 406 apply matrix factorization to predict values for dynamic variables that are unknown based on historic data. In this regard, NBA module 127 can apply matrix factorization algorithms similar to those that may be applied in known “user-item” recommender systems, but with “opportunities” being used to replace the “users” of traditional recommender systems and a set of dynamic variables that represent or embed possible actions being used to being replace the “items” of traditional recommender systems.

Operation 402 is configured to generate and update a deal “D” matrix 500 (FIG. 5) and a base interaction (I) matrix (FIG. 6), which can correspond to the “User” and “User-Item interactions” matrices of a traditional matrix factorization based recommender system.

Referring to FIG. 5, opportunities-static features deal (D) matrix 500, is a N-row by Ns column matrix where: N is a total number of historic and ongoing opportunities 194 included in the set of opportunities O(1), . . . , O(N) that are under consideration; and Ns is number of static features (e.g., dimensions) that are included in a static feature vector FV(j) representation of an opportunity O(j), as generated by opportunity pattern operation 210. Accordingly, each respective opportunity O(j) is represented as row (FV(j)) of static variables. In some examples, the set of opportunities O(1), . . . , to O(N) under consideration may include all historic opportunities 194 and ongoing opportunities 194 that are included in opportunity data 128. In some examples, the set of opportunities may include only successfully closed historic opportunities 194, as well as all currently ongoing opportunities 194. In some examples, the set of opportunities could be limited to historic and open opportunities with a specific target entity. In some examples, the set of opportunities could include data about historic opportunities across multiple enterprises 180 and target entities 190, and data for current opportunities for a subject enterprise 180.

A base interaction (I) matrix 600 is illustrated in FIG. 6. Different dynamic variables can be used for the matrix columns in different examples. In the example of FIG. 6, different types of the performance scores that are computed by performance scoring operation module 206 are used as the dynamic variables. As noted above, performance scores can function as an abstract or coarse embedding of actions that correspond to activity events.

In this regard, in the illustrated example, base I matrix 600 is a N-row by (Np×Nm) column matrix where: N is a total number of historic and ongoing opportunities 194 included in the set of opportunities O(1), . . . , O(N) that are under consideration; Np is number of performance scored PS included in a selected set of performance scores PS(1), PS(Np), and Nm is the number of milestones M included in the set of milestones M(1), M(Nm). In the illustrated example, the set of milestones M(1), M(Nm) corresponds to the milestones that make up the reference OTL described above with reference to FIG. 3.

In example embodiments, the base I matrix 600 can be populated based on known data stored as data objects 124 in relationship database 122. By way of illustration, in the example of FIG. 4, the first opportunity O(1) is a successfully closed opportunity. Upon the achievement of first milestone M(1), the performance scoring module 206 calculated as set of performance scores PS(1), . . . , PS(Np) for the first opportunity O(1) corresponding to the first milestone M(1), and that information was stored as Milestone Data in association with the opportunity data 128 for the first opportunity O(1). Accordingly, over a set of opportunities, a historic record of performance scores PS(1), . . . , PS(Np) is recorded for each achieved milestone for each opportunity, and are thus available for inclusion in the base I matrix 600.

By way of non-limiting illustration, in the example of FIG. 6, the first opportunity O(1) had the following performance scores associated with milestone M(1): PS(1)=0.8, PS(2)=0.7, . . . , PS(Np)=0.9. In one example, Np may be equal to 5, with PS(1) corresponding to “Opportunity Momentum Score”; PS(2) corresponding to “Multi-thread Score(s)”; PS(3) corresponding to “Communication Quality Score(s)”; PS(4) corresponding to Enterprise Team Score; and PS(5) corresponding to Target entity team score.

As indicated above in the description of scoring performance operation 206, at least some of the performance scores (e.g., Opportunity Momentum Score) can have a temporal event as they are based on communication events over a time period. In at least some examples, one or more of the durations used to determine performance scores in respect of a milestone may be a standard default across all milestones, may be set for the specific milestone, or may be based on a duration since the previous milestone (or the start of the opportunity), or a combination thereof. For example, the time period that is used to determine the Opportunity Momentum Score PS(1) in respect of milestone M(2) for an opportunity O(j) may be: the shorter of three weeks or the time since achieving the first milestone M(1). A hard time limit (e.g., three weeks) can filter out stale actions from consideration as being relevant to a milestone achievement. Performance scores that are based on conditions at a specific time (e.g., Enterprise Team Score) can be calculated based on the conditions at the time the milestone is achieved.

In the illustrated example, the Base I matrix 600 is populated based on data that has been automatically collected and processed at one or both of network 110 (for example mail server 112 and VOIP system 113 communications related collected by CRM support agent 114) and data compilation module 125, thus requiring very little or no manual user input. Once an opportunity is closed, its data in Base I matrix 600 will not change and does not have to be updated in subsequent updates. Older closed opportunities may periodically or selectively culled from Base I matrix 600 in some examples.

In the example of FIG. 6, opportunity O(k) corresponds to an ongoing open opportunity for which milestone M(1) has been achieved, and milestone M(2) is in progress. The matrix row corresponding to open opportunity O(k) (and other open opportunities) is sparsely populated, as the performance scores corresponding to milestones M(2) and beyond are not yet known.

It will be noted that base I matrix 600 is effectively a set of N by Np milestone I matrices, labelled as 602(1), . . . , 602(Nm) in FIG. 6, with each milestone I matrix 602(1), . . . , 602(Nm) representing the opportunity-performance score interactions for a respective milestone M(1), M(Nm). In this regard, a 3-dimensional representation of I matrix 600 as an N by Np by Nm matrix, with each respective milestone M(1), M(Nm) being represented at a unique depth or layer (e.g. by a respective milestone I matrix 602(1), . . . , 602(Nm)) is shown in FIG. 7.

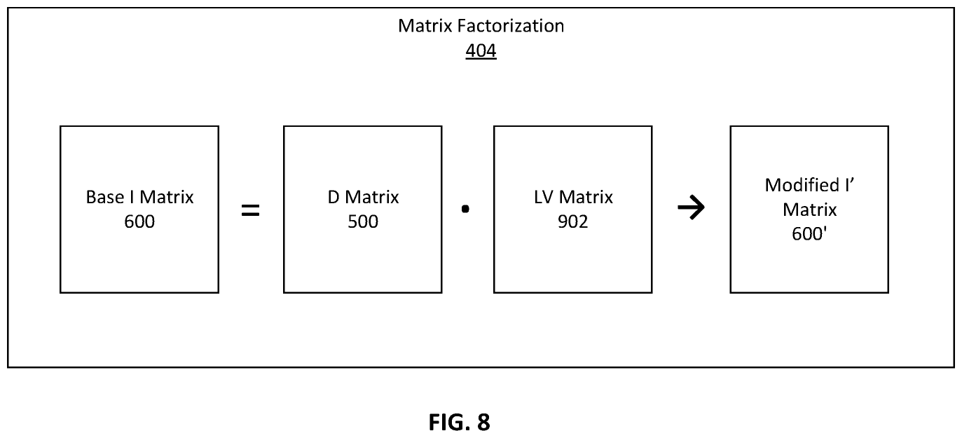

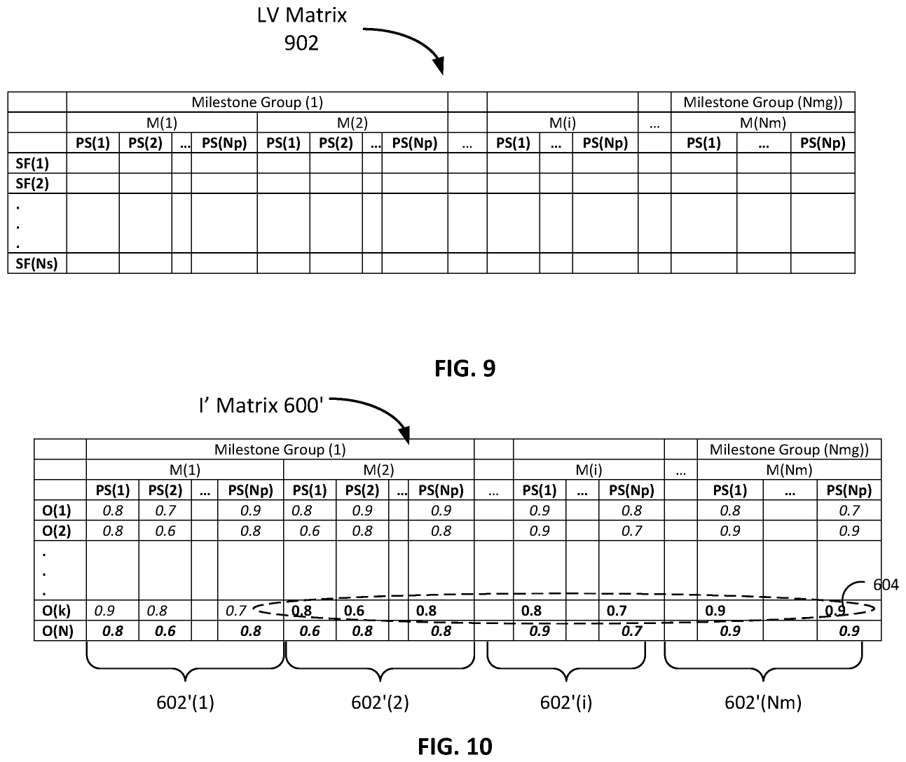

D matrix 500 and base I matrix 600 are based on known data. With Reference to FIG. 8, in example embodiments, NBA module 127 includes matrix factorization operation 404 that uses base I matrix 600 and D matrix 500 to calculate a latent variable (LV) matrix 902 (illustrated in greater detail in FIG. 9) which is then used to calculate missing values in the base I matrix, resulting in approximated I′ matrix 600′ (illustrated in greater detail in FIG. 10).

The LV matrix 902 is a latent variable matrix that may have no real-world interpretation, but that is used to derive, given D matrix 500, a dense approximated I′ matrix 600′ that is related to the interaction matrix I. As shown in FIG. 9, LV matrix 902 is an Ns-row by (Np×Nm) column matrix where: Ns is a total number of static features included in a feature vector FV(.); Np is number of performance scores included in PS(1), . . . , PS(Np); and Nm is the number of milestones M included in the set of milestones M(1), M(Nm).

In example embodiments, matrix factorization operations applies iterative machine learning to learn the values of LV matrix 902 that will enable the dot product of D matrix 500 and LV matrix 902 to generate a fully populated approximated I′ matrix 600′ that minimizes the cost of errors between the performance scores that are included in the base I matrix 600 and the predicted scores included in approximated I′ matrix 600′. For example, an alternative least square algorithm can be applied whereby the D matrix 500 is held constant, and the LV matrix 902 is adjusted to achieve optimized values to minimize a loss function that measures the difference between the known performance scores and the predicted performance scores.

With reference to FIG. 10, at the completion of training the individual matrix values in approximated I′ matrix 600′ should match, or be as similar as training permits, to the pre-existing corresponding values in base I matrix 600, and the values in I′ matrix 600′ (shown in bold in FIG. 10) that correspond to unpopulated locations in base I matrix 600, can be used to provide intelligent recommendations to users 182. In example embodiments, performance scores PS are only included in base I matrix 600 for opportunities when the respective milestone M(.) is achieved. Accordingly, the predicted performance scores included in approximated I′ matrix 600′ can be used to indicated what performance scores should be targeted to successfully achieve a milestone. By way of example, in FIG. 10, the values included in oval 604 are predicted performance scores that, based on similar historic opportunities, should be targeted in order to achieve milestones M(2) to M(Nm).

This, example embodiments, the NBA module effectively learns a set of target performance scores for a current opportunity based on performance scores achieved in respect of successful historic opportunities. Similarity between the opportunities is embedded into the learning process based on the respective sets of static variables (static feature vectors) that are used to define each of the opportunities.

Referring again to FIG. 4, NBA module 127 can include a recommendation determination operation 406 that is configured to map the predicted performance scores for on-going opportunity milestones to concrete user recommendations that can be provided to individual user UEs 104 (for example through an interface provided by NBA recommender module 118).

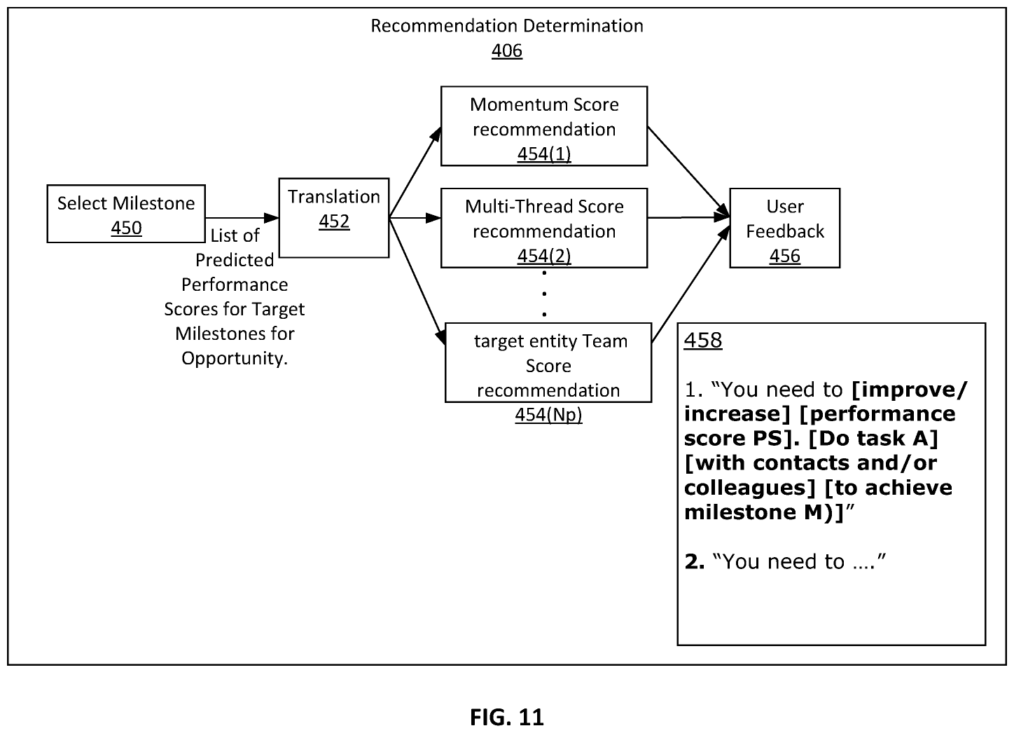

One example of a possible recommendation determination operation 406 for processing predicted performance scores in respect of an opportunity (e.g., predicted scores 604 for opportunity O(k)) is shown FIG. 11. Although shown as part of NBA module 127, some or all of the functions performed by recommendation determination operation 406 could alternatively be moved to NBA recommender 118 and/or the SRMS 108 of a UE device 104.

Recommendation determination operation 406 can include a milestone selection operation 450 for selecting one or more target milestones M(1), M(Nm) in respect of opportunity O(k). For example, milestones that already have been achieved can be ignored (e.g., milestone M(1) in the case of illustrated opportunity O(k)). Furthermore, it may be desirable to limit recommendations to a subset of the as-yet unachieved milestones. For example, a defined number of pending milestones may be selected, for example the next X milestones. In some examples, selected milestones could be limited to the milestones within a current milestone group. In this respect, milestone groups can be automatically “unlocked” once all, or a threshold number, of the milestones in a prior milestone group have been achieved. A list of the corresponding predicted performance scores can then be compiled for the selected target milestones for the subject opportunity O(k) from the predicted performance scores included in approximated I′ matrix 600′. For example, in the illustrated example, as shown in FIG. 10, the predicted performance scores for opportunity O(k), milestone M(2) are: PS(1)=0.8; PS(2)=0.6, . . . , PS(Np)=0.8.

The list of predicted performance scores can then be provided to a translation function 452 that selectively routes the scores to respective recommendation functions 454(1) to 454(Np) based on performance score types. For example, a momentum score recommendation function 454(1) may be provided for processing the predicted opportunity momentum score (e.g., PS(1)=0.8), a multi-threading score recommendation function 454(2) may be provided for processing the predicted multi-threading score (e.g., PS(2)=0.6), and a Target entity Team Score function 454(Np) provided for processing the predicted Target entity team score (e.g., PS(Np)=0.8).

In example embodiments, each of the respective recommendation functions 454(1) to 454(Np) may be configured to calculate, based on the most recent known data objects for the subject opportunity O(k), the current actual performance scores for the opportunity. A delta value can be computed between the current performance scores and the predicted scores for use as feedback data. For example, in the case of subject opportunity O(k), a current opportunity momentum score measuring progress for milestone M(2) can be determined based on events that have occurred since milestone M(1) was achieved, and this score can be compared by momentum score recommendation function 454(1) against the predicted opportunity momentum score (e.g., PS(1)=0.8 for M(2) for O(k)) from approximated I′ matrix 600′.

In examples, the delta values generated by a recommendation function 454(1), 454(Np) can be used to determine one or more specific action recommendations 458 that would enable the respective performance score to be improved. In this regard, action recommendations 458 could take a form such as “You need to [improve/increase] [performance score PS]. [Do task A] [with contacts and/or colleagues] [to achieve milestone M)]”. Action recommendations can have the following metadata associated with them: (1) calculated delta value (can allow recommendations to be ranked by how far away the desired performance score is) (2) Opportunity ID/Target entity ID; (3) Milestone ID; (4) Enterprise team, among other things.

For example, a component of opportunity momentum score can be (ii) Outgoing Emails: Average number of weekly outgoing emails relating to Opportunity (e.g. from Enterprise to Target entity), and the momentum score recommendation function 454(1) could be configured to compute the increase in the number of weekly outgoing emails that would be required to eliminate the delta value (e.g., 0.2), and a resulting recommendation can be “You need to increase opportunity momentum score for opportunity O(k) by 20% to get to a historically successful level of least 80% if you want to achieve Milestone M(2). Increase weekly outgoing emails to members of the target entity team that have a manager position from 3 to 6.”

Similarly, multi-thread score recommendation function 454(2) could be configured to determine that adding a certain contact with a title score in a specified department could increase a calculated current multi-thread score for an opportunity to the predicted multi-thread score, and generate a suitable recommendation.

In example embodiments, feedback data that includes recommendations 458 from the respective recommendation functions 454(1), . . . , 454 (Np) are collected by a user feedback function 456 that is configured to interface with a UE device 104 to provide feedback and recommendations for opportunities to a user 182. For example, user 182 may be the individual listed in opportunity data 128 as the opportunity lead for the subject opportunity O(k), or one of the identified enterprise team members for the opportunity. The feedback data, including information about recommendations 458, may be pushed to a user 182 in an electronic message that is pushed to the user such as in a daily email or in some other manner. The feedback may be provided through a user interface provided by NBA recommender 118 and/or CRMS 108.

In some examples, feedback data may be provided in a periodic digest that the user 182 receives (for example in an email, or through an interface provided by CRMS 108) according to a configurable schedule (e.g. daily, every 3 days or weekly). Deals (i.e., opportunities) that are included in this feedback digest may be filtered such that not all open opportunities (and their associated action recommendations 458) are displayed in each periodic digest. This filtering could be based on several factors such as; how close the opportunity is to closing, how long it's been since recommendations 458 were last provided to or viewed by user 182 for the opportunity, how long since the last milestone was achieved, or the magnitude of the delta between the current performance score and the suggested score. Similarly, the same content may be available in a panel display in the users' email interface and could, for example, be displayed when viewing related content (e.g. an email to/from a contact from that target entity, or a meeting invite relating to the opportunity).

In both the above feedback mechanisms, the user 182 can have the option to sync the recommendations to a task list so that the user 182 can access the information later through their local CRM interface or through their CRMS 108 interface (or other productivity tool). In some examples, the action of users 182 on feedback recommendations 458 can be tracked by CRM support agent and communicated to CRM support system 120, providing the additional benefit of providing user-feedback to the system 120 indicating which recommendations were useful. This information can be used to update the model parameters used in the NBA module 127 to drive more useful recommendations in the future.

The recommendations 458 can also or alternatively be displayed in a dashboard format on an interface provided on UE device 104 by CRMS 108 so that the user 182 can easily find recent recommendations for particular opportunities. In this example, no filtering will be done a priori, but users 182 will be supplied with a suite of filters as well as search functionality that they can apply to view a particular opportunity, or a subset of opportunities.

### Alternative Embodiment—Direct Use of Actions Matrix Factorization

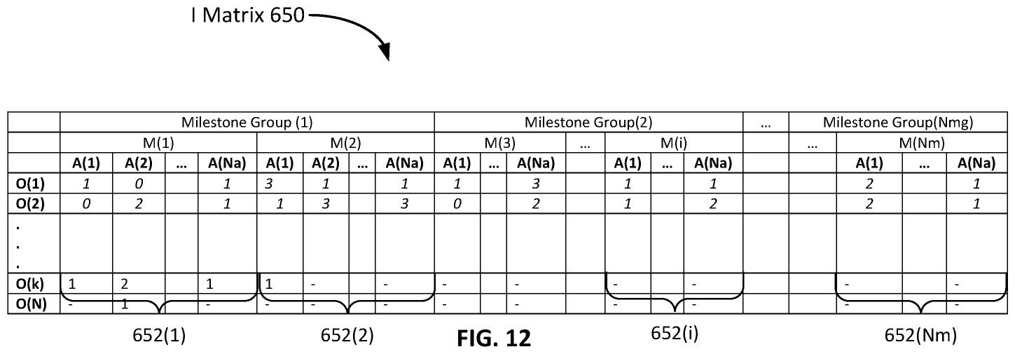

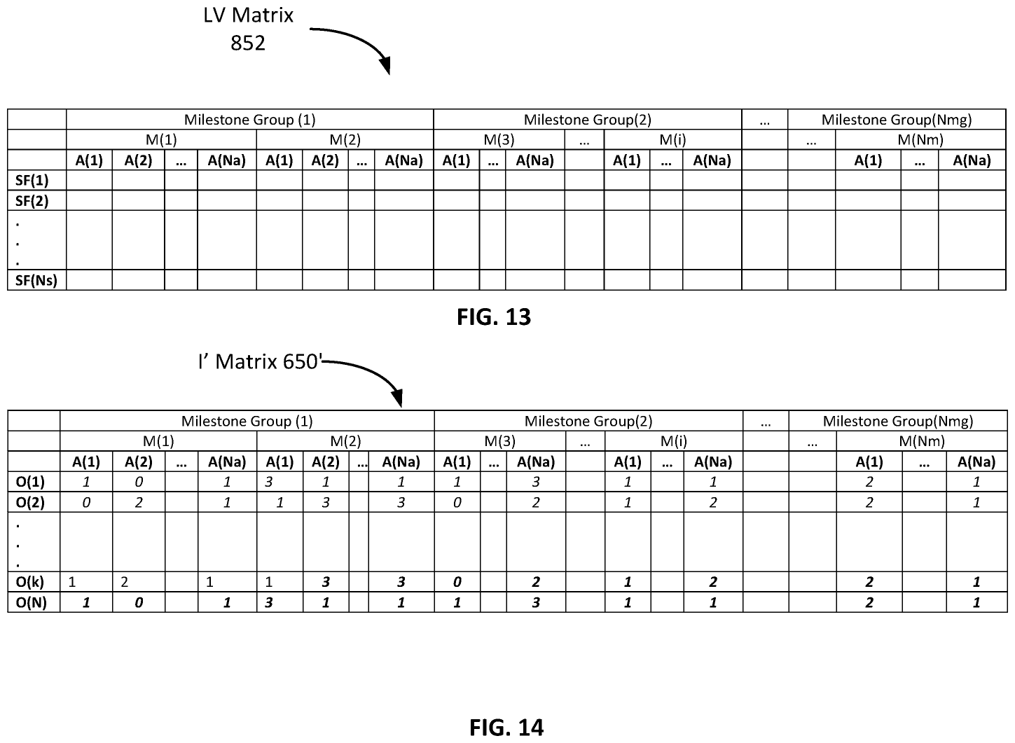

In the above described example, performance scores PS(1), . . . , PS(Np) are used as a proxy for actual actions in the matrices that are used by matrix factorization operation 404. In some example's, actual actions A(1), . . . A(Na) may be used instead as the dynamic variables. In this regard, FIG. 12 shows an alternative base I matrix 650, FIG. 13 shows an alternative latent vector LV matrix 852 and FIG. 14 and shows an alternative approximated I′ matrix 650′. In each of these matrices, action variables have been substituted for performance scores. I matrix 650 is a N-row by (Na×Nm) column matrix where: N is a total number of historic and ongoing opportunities 194 included the of opportunities O(1), . . . , O(N) that are under consideration; Na is number of candidate actions A included in the set of candidate actions A(1), . . . , A(Na); and Nm is the number of milestones M included in the set Sm of milestones M(1), M(Nm).

In example embodiments, the I matrix 650 can be populated based on the content of data objects 124 stored as relationship data 122, including for example opportunity data 128 and activity data 136. By way of illustration, in the example of FIG. 12, the first opportunity O(1) is a successfully closed opportunity. In a time period associated with achievement of the first milestone M(1), the activity data 136 associated with first opportunity O(1) includes records that indicate that: one incident of action A(1) occurred (e.g., there was 1 outgoing email from enterprise user to one or more target entity users); zero incidents of action A(2) occurred (e.g., 0 outgoing calendar invites to one or more target entity users; and one incident of action A(Na) occurred (e.g., 1 in-person meeting with target entity users having a title score that exceeds a defined threshold). In a time period associated with achievement of the second milestone M(2), the activity data 136 associated with first opportunity O(1) includes records that indicate that: three incidents of action A(1) occurred (e.g., there was 3 outgoing email from enterprise user to one or more target entity users); one incident of action A(2) occurred (e.g., 1 outgoing calendar invite to one or more target entity users; and one incident of action A(Na) occurred (e.g., 1 in-person meeting with target entity users having a title score that exceeds a defined threshold).

The duration of the time periods associated may be set for each milestone, or may be based on the duration since the previous milestone (or the start of the opportunity), or a combination thereof. For example, the time period that is used to determine the number of action incidents associated with second milestone M(2) may be: the shorter of three weeks or the time since achieving the first milestone M(1). A hard time limit (e.g., three weeks) can filter out stale actions from consideration as being relevant to a milestone achievement.

In the example of FIG. 12, opportunity O(k) corresponds to an ongoing open opportunity for which milestone M(1) has been achieved, and milestone M(2) is in progress. The matrix row corresponding to open opportunity O(k) (and other open opportunities) is sparsely populated, as the actions required to achieve milestones M(2) and beyond have not yet occurred. I matrix 650 can also be considered as a set of N by Na milestone matrices, labelled as 652(1), . . . , 652(Nm) in FIG. 12, with each milestone I matrix 652(1), . . . , 652(Nm) representing the opportunity-action interactions for a respective milestone M(1), . . . , M(Nm). The resulting approximated I′ matrix 650′ (generated by matrix factorization operation 404) is shown in FIG. 14

Referring to FIG. 13, a “static features—actions” latent variable (“LV”) matrix 852 is shown as an Ns-row by (Na×Nm) column matrix where: Ns is a total number of static features SF included in a feature vector FV(.); Na is number of candidate actions A included in the set Sa of candidate actions A(1), . . . , A(Na); and Nm is the number of milestones M included in the set of milestones M(1), . . . , M(Nm).

The predicted actions that are included in approximated I′ matrix 650′ can be used in a similar manner as described above in respect of predicted performance scores to generate feedback and action recommendations for a user 182. For example, the predicted number of a specific type of actions for a pending milestone can be compared with an actual tracked number and a delta value used to generate a recommendation.

In at least some examples, the described systems and methods may improve the efficiency and accuracy of performing comparative data analysis to generate action recommendations, thereby enabling one or more of the CRM system computing devices that make up the CRM support system 120, CRM system 168 and enterprise network 110 to expend fewer computing resources, consume less power and/or require fewer data and power consuming human interactions than might otherwise be required to achieve similar results in the absence of the disclosed systems and methods.

Data objects 124 can be electronically stored in various database formats in different embodiments. In some examples, data objects 124 may include records stored as part of relational database. In some examples a record may be a virtual record that identifies or links to other data sources for the actual content of the feature field of that record. In some cases, feature fields of a record may include sub-records comprising multiple fields or links to such sub-records.

Example Computer System

In example embodiments, the components, modules, systems and agents included in enterprise network 110, CRM support system 120 and CRM system 168 can be implemented using one or more computer devices, servers or systems that each include a combination of a hardware processing circuit and machine-readable instructions (software and/or firmware) executable on the hardware processing circuit. A hardware processing circuit can include any or some combination of a microprocessor, a core of a multi-core microprocessor, a microcontroller, a programmable integrated circuit, a digital signal processor, or another hardware processing circuit.

Referring to FIG. 15, an example embodiment of a computer system 2010 for implementing one or more of the modules, systems and agents included in enterprise network 110, CRM support system 120 and CRM system 168 will be described. In example embodiments, computer system 2010 may be a computer server. The system 2010 comprises at least one processor 2004 which controls the overall operation of the system 2010. The processor 2004 is coupled to a plurality of components via a communication bus (not shown) which provides a communication path between the components and the processor 2004. The system comprises memories 2012 that can include Random Access Memory (RAM), Read Only Memory (ROM), a persistent (non-volatile) memory which may one or more of a magnetic hard drive, flash erasable programmable read only memory (EPROM) (“flash memory”) or other suitable form of memory. The system 2010 includes a communication module 2030.

The communication module 2030 may comprise any combination of a long-range wireless communication module, a short-range wireless communication module, or a wired communication module (e.g., Ethernet or the like) to facilitate communication through communication network 150.

Operating system software 2040 executed by the processor 2004 may be stored in the persistent memory of memories 2012. A number of applications 202 executed by the processor 2004 are also stored in the persistent memory. The applications 2042 can include software instructions for implementing the systems, methods, agents and modules described above.

The system 2010 is configured to store data that may include data objects such as data objects 124.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure. All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

1. A computer implemented method, comprising:
storing in an electronic storage, for each of a plurality of historic opportunities and at least one current opportunity, a respective set of static variables, each static variable representing a respective opportunity attribute;
collecting, using automated data collection, temporal data for actions performed using one or more computer systems in respect of the plurality of historic opportunities and the current opportunity;
transforming the collected temporal data to obtain, for each of the plurality of historic opportunities, a respective set of dynamic variables that correspond to an achievement of a target milestone for the historic opportunity;
predicting, based on the respective sets of static variables and the respective sets of dynamic variables, a respective set of the dynamic variables for the current opportunity; and
outputting a recommendation of one or more actions for achieving the target milestone for the current opportunity based on the predicted set of the dynamic variables for the current opportunity.

2. The method of claim 1 wherein predicting the respective set of the dynamic variables for the current opportunity comprises:
organizing the respective sets of static variables for the historic opportunities and the current opportunity into a static matrix;
organizing the respective sets of dynamic variables determined for the historic opportunities into a base interaction matrix; and
performing matrix factorization to iteratively learn, based on the base interaction matrix and the static matrix, an approximated interaction matrix that includes a prediction for the set of the dynamic variables for the current opportunity.

3. The method of claim 2 wherein outputting the recommendation comprises generating an electronic message that indicates the one or more actions and providing the electronic message to a user associated with the current opportunity.

4. The method of claim 1 comprising:
storing a reference opportunity timeline that includes an ordered list of milestones;
selecting the target milestone from the ordered list of milestones based on the temporal data collected for one or more actions performed using the one or more computer systems in respect of the current opportunity.

5. The method of claim 4 wherein the one or more actions performed using the one or more computer systems in respect of the current opportunity includes a communication action that includes language content, and selecting the target milestone is based on detection of occurrence of a milestone preceding the target milestone in the ordered list of milestones based on natural language processing of the language content.

6. The method of claim 5 wherein transforming the collected temporal data is performed to obtain, for each of the plurality of historic opportunities, a respective set of the dynamic variables for each of the milestones included in the ordered list of milestones.

7. The method of claim 1 wherein, for each historic opportunity, the respective set of dynamic variables includes one or more performance scores computed based on communication actions performed in respect of the historic opportunity.

8. The method of claim 7 wherein the communications actions include electronic messages exchanged between parties associated with the historic opportunity.

9. The method of claim 7 wherein, for the current opportunity, the predicted set of the dynamic variables includes a future performance score that corresponds to one or more possible future communication actions that can be performed in respect of the current opportunity, and
outputting the recommendation of the one or more actions for achieving the target milestone for the current opportunity comprises indicating one or more future communications actions that will enable the future performance score to be achieved.

10. The method of claim 9 wherein the respective set of dynamic variables obtained for each historic opportunity includes a plurality of the performance scores computed based on communication actions, wherein the respective set of the dynamic variables predicted for the current opportunity includes a plurality of future performance score based on future communication actions performed in respect of the current opportunity, and outputting the recommendation of the one or more actions for achieving the target milestone for the current opportunity comprises indicating one or more future communications actions that will enable the plurality of future performance scores to be achieved.

11. The method of claim 10 wherein plurality of the performance scores and plurality of future performance scores each include at least: (1) a first score that is indicative of an opportunity momentum based on a frequency of communications; and (2) a second score that is indicative of multi-threading based on participants communication participants.

12. The method of claim 1 wherein the respective set of dynamic variables obtained for each historic opportunity include indications of communication actions included in the temporal data for actions performed in respect of the historic opportunity.

13. A computer implemented method, comprising:
collecting, using automated data collection, data about a plurality of opportunities that include historic opportunities and at least one current opportunity;
based on the collected data:
generating, for each of the historic opportunities, a respective static feature vector that comprise a plurality of static variables that describe respective attributes of the historic opportunities;
generating, for the current opportunity, a respective static feature vector that comprises a plurality of static variables that describe respective attributes of the current opportunity; and
determining, for each of the historic opportunities, a respective set of dynamic variables that correspond to an achievement of a milestone;
generating a base interaction matrix that includes the set of dynamic variables determined for each of the historic opportunities;
generating a static matrix that includes the respective static feature vector for each of the historic opportunities and the current opportunity; and
performing matrix factorization to compute, based on the base interaction matrix and the static matrix, an approximated interaction matrix that includes predictions for a set of the dynamic variables for the current opportunity; and
outputting a recommendation of one or more actions for achieving the milestone for the current opportunity based on the predictions for the set of the dynamic variables for the current opportunity.

14. A computer system that comprises non-transitory digital storage operatively coupled to one or more processors, the digital storage storing software instructions that when executed by the one or more processors configure the computer system to perform a method comprising:
storing in the digital storage, for each of a plurality of historic opportunities and at least one current opportunity, a respective set of static variables, each static variable representing a respective opportunity attribute;
collecting, using automated data collection, temporal data for actions performed using one or more computer systems in respect of the plurality of historic opportunities and the current opportunity;
transforming the collected temporal data to obtain, for each of the plurality of historic opportunities, a respective set of dynamic variables that correspond to an achievement of a target milestone for the historic opportunity;
predicting, based on the respective sets of static variables and the respective sets of dynamic variables, a respective set of the dynamic variables for the current opportunity; and
outputting a recommendation of one or more actions for achieving the target milestone for the current opportunity based on the predicted set of the dynamic variables for the current opportunity.

15. The computer system of claim 14 wherein predicting the respective set of the dynamic variables for the current opportunity comprises:
organizing the respective sets of static variables for the historic opportunities and the current opportunity into a static matrix;
organizing the respective sets of dynamic variables determined for the historic opportunities into a base interaction matrix; and
performing matrix factorization to iteratively learn, based on the base interaction matrix and the static matrix, an approximated interaction matrix that includes a prediction for the set of the dynamic variables for the current opportunity.

16. The computer system of claim 15 wherein outputting the recommendation comprises generating an electronic message that indicates the one or more actions and providing the electronic message to a user associated with the current opportunity.

17. The computer system of claim 14 comprising:
storing a reference opportunity timeline that includes an ordered list of milestones;
selecting the target milestone from the ordered list of milestones based on the temporal data collected for one or more actions performed using the one or more computer systems in respect of the current opportunity.

18. The computer system of claim 17 wherein the one or more actions performed using the one or more computer systems in respect of the current opportunity includes a communication action that includes language content, and selecting the target milestone is based on detection of occurrence of a milestone preceding the target milestone in the ordered list of milestones based on natural language processing of the language content.

19. The computer system of claim 18 wherein transforming the collected temporal data is performed to obtain, for each of the plurality of historic opportunities, a respective set of the dynamic variables for each of the milestones included in the ordered list of milestones.

20. The computer system of claim 14 wherein
the respective set of dynamic variables obtained for each historic opportunity includes one or more performance scores computed based on communication actions included in the temporal data for actions performed in respect of the historic opportunity
the respective set of the dynamic variables predicted for the current opportunity includes a future performance score based on future communication actions performed in respect of the current opportunity, and
outputting the recommendation of the one or more actions for achieving the target milestone for the current opportunity comprises indicating one or more future communications actions that will enable the future performance score to be achieved.
